(19) United States
(12) Patent Application Publication
(10) Pub. No.: US 2026/0212117 A1
(43) Pub. Date: Jul. 23, 2026

(54) CONTENT-BASED MODEL WEIGHT ADJUSTMENT

(71) Applicant: Salesforce, Inc., San Francisco, CA (US)

(72) Inventors: Akash Singh, Hyderabad (IN); Rajdeep Dua, Hyderabad (IN)

(21) Appl. No.: 19/033,406

(22) Filed: Jan. 21, 2025

(51) Int. Cl. G06F 40/20

(52) U.S. Cl. CPC G06F 40/20

(57) ABSTRACT

Users of a cloud platform may utilize a large language model (LLM) service. The service may configure a first and second agent with a first and second prompt and a third agent with the first prompt at the first agent. The service may obtain, from the first agent, a message with content generated via the first agent. The service may obtain, from the third agent, a control message that includes an indication associated with the content of the message. Further, in response to obtaining the control message and the control message indication, the service may switch from applying one set of parameter weights to an LLM associated the first agent to applying another set of parameter weights. Moreover, the service may output, to the second agent the message from the first agent and then the service may switch back to applying the initial set of parameter weights to the LLM.

### FIELD OF TECHNOLOGY

The present disclosure relates generally to database systems and data processing, and more specifically to content-based model weight adjustment.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some examples, users of a cloud platform or another type of system may utilize entities (e.g., agents) of large language models (LLMs) to automate tasks. For example, a user may utilize an LLM agent to automate communications and the LLM agent may receive natural language text inputs and generate natural language text outputs in response to the inputs. To generate the outputs, LLM agents may be configured with sets of parameters for LLM prompts that indicate instructions for generating an output in response to an input. However, in some cases, LLM agents may diverge from the instructions or violate configurations indicated via the LLM prompts resulting in outputs from the LLM agents being inconsistent with the parameters of the LLM prompts and communications from LLM agents being inconsistent, inaccurate, and unreliable.

### BRIEF DESCRIPTION OF THE DRAWINGS

FIG. 1 illustrates an example of a computing system that supports content-based model weight adjustment in accordance with aspects of the present disclosure.

FIG. 2 shows an example of a computing system that supports content-based model weight adjustment in accordance with aspects of the present disclosure.

FIG. 3 shows an example of a large language model (LLM) agent communication system that supports content-based model weight adjustment in accordance with aspects of the present disclosure.

FIG. 4 shows an example of a process flow that supports content-based model weight adjustment in accordance with aspects of the present disclosure.

FIG. 5 shows a block diagram of an apparatus that supports content-based model weight adjustment in accordance with aspects of the present disclosure.

FIG. 6 shows a block diagram of an LLM service that supports content-based model weight adjustment in accordance with aspects of the present disclosure.

FIG. 7 shows a diagram of a system including a device that supports content-based model weight adjustment in accordance with aspects of the present disclosure.

FIG. 8 shows a flowchart illustrating methods that support content-based model weight adjustment in accordance with aspects of the present disclosure.

### DETAILED DESCRIPTION

In some examples, a system may use large language models (LLMs) which are an example of a type of artificial intelligence (AI) or machine learning (ML) model (e.g., an AI/ML model) to understand, generate, and manipulate human language. In some cases, an LLM may be trained on a relatively large corpus of data that includes text from various different sources enabling the LLM to be capable of performing a relatively wide range of language-related tasks such as text generation, translation, summarization, and conversational interactions, by recognizing patterns and context within the data.

In some examples, the system may also utilize one or more LLM agents which may be entities configured to process and generate human-like text. In some cases, users of a system may use the LLM agents to perform various tasks that an LLM is capable of performing. By utilizing an LLM agent, a user may be capable of automating one or more tasks thus making the LLM agents relatively versatile for various applications across different industries. Therefore, a user may use an LLM agent to perform tasks which may be relatively difficult to regulate or control when done manually. For example, LLM agents may be used for communication or negotiation with other users or LLM agents. In some cases, when communicating or negotiating with others, users may have to create strategies for conversations which may be relatively difficult to maintain during a conversation. For example, when negotiating a product, a user may end up closing a deal at a lower price than intended or than an initial target.

In accordance with the techniques of the present disclosure, an LLM service may be utilized for LLM prompt parameter weight control to ensure consistency between interactions of LLM agents. For example, the LLM service may configure a first LLM agent and a second LLM agent with a first set of parameters for a first LLM prompt and a second set of parameters for a second LLM prompt for the first LLM agent and the second LLM agent to communicate with each other. Moreover, the first set of parameters for the first LLM prompt and the second set of parameters for the second LLM prompt may be different at the first LLM agent and the second LLM agent. The LLM service may also configure a third LLM agent with the first set of parameters for the first LLM prompt at the first LLM agent in response to configuration of the first LLM agent. Then, the LLM service may receive a first message from the first LLM agent that includes a first set of content that is generated based on the first set of parameters for the first LLM prompt at the first LLM agent and on the second set of parameters for the second LLM prompt at the first LLM agent.

Further, the LLM service may forward the first message from the first LLM agent to the third LLM agent and the LLM service may receive a control message from the third LLM agent. The control message may include an indication that is based on the first set of content of the first message. In response to obtaining the control message from the third LLM agent and based on the indication of the control message, the LLM service may switch from applying a first set of parameter weights to an LLM associated with the first LLM agent to applying a second set of parameter weights to the LLM. Further, the LLM service may output the first message to the second LLM based on the indication of the control message and switching to applying the second set of parameter weights to the LLM. Moreover, in response to outputting the first message, the LLM service may switch from applying the second set of parameter weights to the LLM associated with the first LLM agent back to applying the first set of parameter weights to the LLM.

In some examples, the indication of the control message from the third LLM agent may be a positive indication to indicate that the first set of content of the first message is in accordance with the first LLM prompt at the first LLM agent. In some other examples, the indication of the control message from the third LLM agent may be a negative indication based on the first set of content of the first message violating a configuration indicated by the first LLM prompt at the first LLM agent. Thus, in response to receiving a negative indication via the control message, the LLM service may switch to applying the second set of parameter weights to the LLM associated with the first LLM agent and may refrain from outputting the first message with the first set of content.

Further, while the second set of parameter weights are applied, the LLM service may obtain a second set of content for the first message from the first LLM agent. In response, the LLM service may receive a second control message from the third LLM agent. In some cases, the indication of the second control message may be a positive indication and thus the LLM service may output the first message with the second set of content to the second LLM agent. Thus, the third LLM agent may prevent the first LLM agent from transmitting messages to the second LLM agent that violate the configuration of the first LLM prompt at the first LLM agent. Further, when the content of a respective message from the first LLM agent does violate the configuration of the first LLM prompt at the first LLM agent, the third LLM agent may indicate, via the control message, for the LLM service to switch to applying a respective set of parameter weights. The respective set of parameter weights that the LLM service may switch to applying may be associated with placing a relatively higher weight or importance on the configuration of the first LLM prompt at the first LLM agent to ensure that a subsequent set of content is in accordance with the first LLM prompt. Thus, the techniques of the present disclosure may ensure that messages that violate LLM prompt configurations are unable to be transmitted and may enable an LLM service to switch which parameter weights are applied for generating subsequent messages.

Aspects of the disclosure are initially described in the context of an environment supporting an on-demand database service. Additional aspects of the disclosure are described with reference to a computing system, an LLM agent communication system, and a process flow. Aspects of the disclosure are further illustrated by and described with reference to apparatus diagrams, system diagrams, and flowcharts that relate to content-based model weight adjustment.

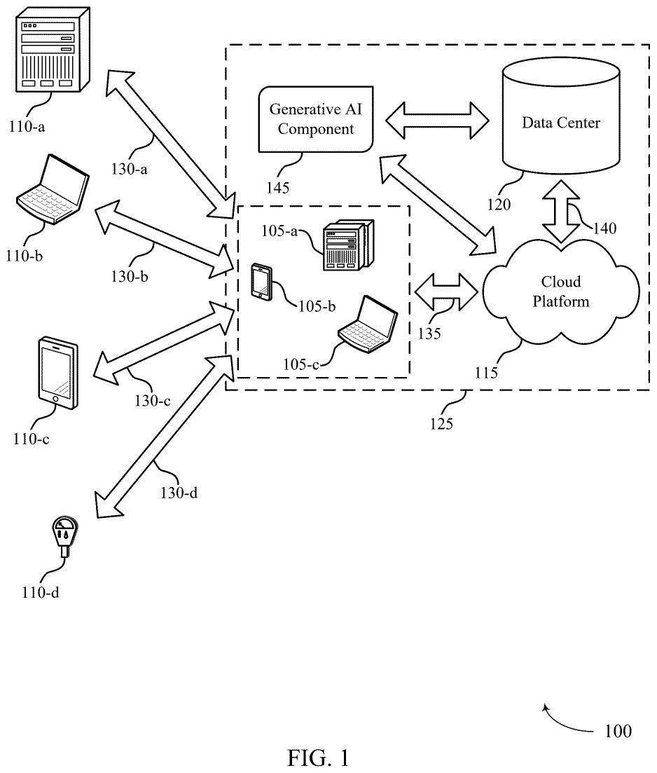

FIG. 1 illustrates an example of a system 100 for cloud computing that supports content-based model weight adjustment in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples, the generative AI component 145 of the system 100 may also utilize one or more LLM agents which may be entities configured to process and generate human-like text. In some cases, users of the system 100 may use the LLM agents to perform various tasks that an LLM is capable of performing. By utilizing an LLM agent, a user may be capable of automating one or more tasks thus making the LLM agents relatively versatile for various applications across different industries. Therefore, a user may use an LLM agent to perform tasks which may be relatively difficult to regulate or control when done manually. For example, LLM agents may be used for communication or negotiation with other users or LLM agents. In some cases, when communicating or negotiating with others, users may have to create strategies for conversations which may be relatively difficult to maintain during a conversation. For example, when negotiating a product, a user may end up closing a deal at a lower price than intended or than an initial target.

In accordance with the techniques of the present disclosure, the generative AI component 145 may be utilized for LLM prompt parameter weight control to ensure consistency between interactions of LLM agents. For example, the generative AI component 145 may configure a first set of parameters for a first LLM prompt and a second set of parameters for a second LLM prompt for a first LLM agent (e.g., a seller agent) and the second LLM agent (e.g., a buyer agent) to communicate with each other. In some cases, the first set of parameters for the first LLM prompt may indicate a set of instructions for how the seller agent and buyer agent should interact. For example, the first set of parameters for the first LLM prompt at the first LLM agent (e.g., the seller agent) may include a parameter that indicates that the first LLM agent should refrain from accepting a deal that is lower than a respective price. Similarly, the first set of parameters for the first LLM prompt at the second LLM agent (e.g., the buyer agent) may include a parameter that indicates that the second LLM agent should refrain from accepting a deal that is higher than a respective price. Further, the second set of parameters for the second LLM prompt may be based on the conversation or interactions between the first LLM agent and the second LLM agent. Therefore, the first set of parameters for the first LLM prompt and the second set of parameters for the second LLM prompt may be different at the first LLM agent and at the second LLM agent.

The generative AI component 145 may also configure a third LLM agent (e.g., a supervisor agent) with the first set of parameters for the first LLM prompt at the first LLM agent in response to configuration of the first LLM agent. For example, the third LLM agent may be configured to monitor the operations of the first LLM agent to ensure that the first LLM agent refrains from violating a configuration indicated by the first set of parameters for the first LLM prompt at the first LLM agent. Thus, in accordance with the techniques of the present disclosure, utilizing the generative AI component 145, the first LLM agent may generate that includes a first set of content based on the first set of parameters for the first LLM prompt at the first LLM agent and on the second set of parameters for the second LLM prompt at the first LLM agent to generate a first message for the second LLM agent. For example, the first LLM agent (e.g., the seller agent) may generate a message for the second LLM agent (e.g., the buyer agent) that indicates a proposed price for a product. In response, the third LLM agent (e.g., the supervisor agent) may monitor and obtain the first message from the first LLM agent (e.g., the generative AI component 145 may obtain the first message and forward the first message to the third LLM agent).

After obtaining the first message, the third LLM agent may output a control message that the generative AI component 145 may obtain and forward to the first LLM agent. In some examples, the control message may indicate an indication of whether the first content of the first message is in accordance with the first set of parameters of the first LLM prompt at the first LLM agent. That is, the control message may include a positive indication that indicates that the first message is in accordance with the instructions given to the seller agent for generating messages. In some other examples, the control message may indicate an indication that the first message is in violation of a configuration indicated via the first LLM prompt at the first LLM agent. That is, the control message may include a negative indication that indicates that the content of the first message is not in accordance with the instructions given to the seller agent for generating messages. In such cases where the control message indicates a negative indication, the generative AI component 145 may prevent the first LLM agent from transmitting the first message to the second LLM agent. Moreover, to ensure that a message can be generated in accordance with the first LLM prompt at the first LLM agent, the generative AI component 145 of the subsystem 125 may switch from applying a first set of parameter weights to the LLM associated with the first LLM agent to applying a second set of parameter weights to the LLM. For example, the second set of parameter weights may be configured to ensure that the first LLM agent (e.g., the seller agent) follows the instructions of the first LLM prompt relatively more closely.

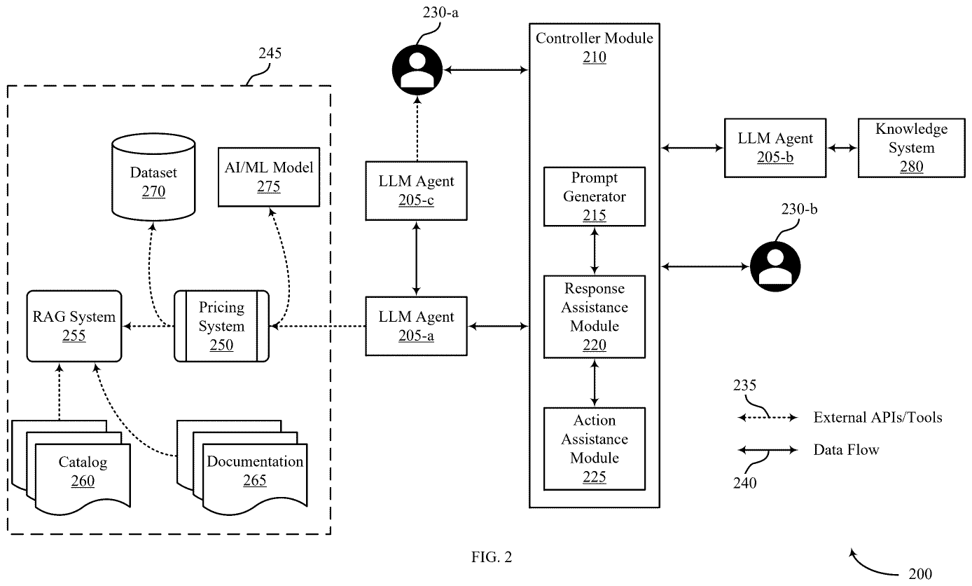

Utilizing the LLM associated with the first LLM agent with the second set of parameter weights applied, the first LLM agent may generate a second set of content for the first message for the third LLM agent to review. In response, the third LLM agent may output a second control message and if the second control message indicates a negative indication again, the first LLM agent may be triggered to regenerate the content for the first message again utilizing the LLM with the second set of parameter weights applied until a respective control message indicates a positive indication. Once a positive indication is received, the first message may be forwarded to the second LLM agent and the generative AI component 145 may switch back to applying the first set of parameter weights to the LLM associated with the first LLM agent to allow increased flexibility in generating subsequent messages. Thus, the techniques of the present disclosure may enable the generative AI component 145 of the system 100 (e.g., the subsystem 125 of the system 100) to switch to applying different sets of parameter weights to an LLM for LLM agents to generate messages when the messages generated by LLM agents start to diverge and violate configurations. Moreover, switching the sets of parameter weights may thus ensure consistent and accurate communications between LLM agents within the system 100. Further descriptions of the techniques of the present disclosure may be described elsewhere herein, such as with reference to FIGS. 2 through 4.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 2 shows an example of a computing system 200 that supports content-based model weight adjustment in accordance with aspects of the present disclosure. In some examples, the computing system 200 may implement or be implemented by the system 100. For example, the computing system 200 may include one or more LLM agents 205 (e.g., an LLM agent 205-a, an LLM agent 205-b, an LLM agent 205-c), and a controller module 210 that may be implement or be implemented by corresponding devices or services described herein with reference to FIG. 1, such as the generative AI component 145. Further, the controller module 210 may include a prompt generator 215, a response assistance module 220, and an action assistance module 225, which may be associated with the generative AI component 145 as described with reference to FIG. 1. Moreover, the computing system 200 may include one or more users 230 (e.g., a user 230-a, a user 230-b) that may utilize be associated with cloud clients 105 or contacts 110 as described with reference to FIG. 1. Additionally, or alternatively, components, services, devices, and the like of the computing system 200 may communicate via external communications 235 (e.g., external tools such as application programming interfaces (APIs)), as illustrated by the dashed lines herein, or via data flows 240, as illustrated by the solid lines herein. However, it should be understood by one having ordinary skill in the art that the components, services, devices, and the like of the computing system 200 may communicate via other communication techniques as described herein.

In some examples, the computing system 200 may be referred to as an agentic system. An agentic system may be a type of AI system that includes one or more agents (e.g., LLM agents 205) that can pursue independent goals, make decisions and determinations, and perform one or more actions. Further, the computing system 200 may be an agentic system based on the LLM agents 205 of the computing system 200 communicating with each other, with users 230, or both to perform one or more actions. For example, the LLM agent 205-a may communicate with the LLM agent 205-b to perform a contract negotiation on the behalf of the user 230-a and the user 230-b respectively. In some cases, the LLM agent 205-a may also directly communicate with the user 230-b to perform the contract negotiation. In such cases, the LLM agent 205-a and the LLM agent 205-b may be referred to as negotiator agents. Further, the LLM agent 205-a may be referred to as a seller agent that acts as a salesperson that is selling goods or providing a service and the LLM agent 205-b may be referred to as a buyer agent that represents a customer interested in purchasing the goods or services provided by the seller agent. Further, in accordance with the techniques of the present disclosure, the LLM agent 205-c may be referred to as a supervisor agent that monitors the interactions between the seller agent (e.g., the LLM agent 205-a) and the buyer agent (e.g., the LLM agent 205-b) to ensure that guidelines, instructions, configurations, and the like are followed. In some examples, if the LLM agent 205-a, the LLM agent 205-b, or both diverge from or violate the established guidelines, instructions, or configurations, of the respective LLM agent 205, the LLM agent 205-c may then send one or more control messages (e.g., course correct messages) to the respective LLM agents 205, request for human user (e.g., the user 230-a or the user 230-b) intervention or support, or a combination thereof.

In some examples, the computing system 200 may include a subsystem 245 that illustrates a pricing system 250. The pricing system 250 may be a wrapper over a set of external tools and APIs. The subsystem 245 may include a RAG system 255 that is configured on top of a product catalog 260 and product documentation 265. Further, the RAG system 255 may communicate with the product catalog 260 and the product documentation 265 via the external communications 235. In some examples, the product catalog 260 may include a set of descriptions, configurations, pricing information, technical specifications, and the like for a set of products. Further, the product documentation 265 may include a manual (e.g., a text document) for a respective product that includes descriptions of the respective product, features of the respective product, installation information for the respective product, troubleshooting information for the respective product, and the like. In some cases, the product catalog 260 may include one or more products and information on each product of the one or more products and the product documentation 265 may include documentation for each product within the one or more products of the product catalog 260.

Further, within the subsystem 245, the pricing system 250 may communicate, via the external communications 235, with the RAG system 255 to obtain information for respective products. In some cases, the pricing system 250 may communicate, via the external communications 235, with a dataset 270 that may be a quote and deal dataset. The dataset 270 may include one or more quotes and deals completed by an organization. For example, the dataset 270 may include a first data item that is associated a product sold by the organization and the first data item may indicate information associated with the product that was sold, the deal the resulted in the product being sold, information associated the buyer of the product, and the like. Further, the pricing system 250 may also communicate, via the external communications 235, with an AI/ML model 275 that may be referred to as a pricing model. In some examples, the AI/ML model 275 may be an example of a regression model that is trained on the data within the dataset 270 and may be configured to output the price of a product or quote_line given a set of input factors. For example, the AI/ML model 275 may consider information such as the product, the customer industry, the customer size (e.g., the size of an organization associated with the customer), a sales geography, or any combination thereof. Further, in some cases, the AI/ML model 275 may generate or output the price for a quote as a function of a set of information (e.g., quote_price=f (product, quantity, customer_industry, customer_size, sales_geography, list_price)). Therefore, the pricing system 250 may utilize the AI/ML model 275 to determine an accurate and fair price for a product based on details about the products quantity, customer characteristics, and deal and quote parameters.

Further, the pricing system 250 may also act as an assistant to the LLM agent 205-a, the LLM agent 205-c, or both by proving information to the LLM agents. For example, the pricing system 250 may have information about the products sold by an organization and may be configured or input with the business requirements of a customer/buyer such that the pricing system 250 can provide recommendations for the correct set of products to address the requirements of the customer/buyer. Moreover, the pricing system 250 may interact, via the external communications 235, with the RAG system 255 to obtain such information as the RAG system 255 may store information about product features, data on customer requirements, and data on products sold from the quote and deal data within the dataset 270.

In some examples, the subsystem 245 may be used such that the pricing system 250 can respond to queries from a seller to recommend products for a customer. As such, the pricing system 250 of the subsystem 245 may use the RAG system 255 to search for products that match a set of requirements of customer requirements provided or shared by the seller. For example, via the external communications 235, the pricing system 250 may transmit one or more API requests to the subsystem 245 to obtain information about products. Moreover, the pricing system 250 may also be capable of providing pricing information. For example, a seller may query (e.g., via API queries using the external communications 235) the pricing system 250 to suggest a price for a product and the pricing system 250 may compute a price for the respective product on a product by product basis. That is, the pricing system 250 may provide the price for each individual product queried about rather than a total price, or in addition to providing a total price for multiple products. Additionally, or alternatively, the pricing system 250 may also obtain information associated with related products, licenses, services such as customer support, and the like by using a combination of data from the product catalog 260, the product documentation 265, and the dataset 270.

Further, a seller agent (e.g., the LLM agent 205-a, the user 230-a, or both) may be capable of obtaining, via the external communications 235, information from the pricing system 250 for negotiations to obtain a favorable deal or result in a negotiation. For example, the pricing system 250 may provide a seller agent with an appropriate price for a respective product that is computes based on similar deals and quotes completed in the recent past. In some cases, the price for the respective product may also be different from a listed price (e.g., higher or lower than the listed price) which may allow the seller agent to negotiate with a customer on the price. The pricing system 250 may also be capable of providing the seller agent with data of a quantity of licenses similar customers may be expected to purchase. For example, the pricing system 250 may utilize information associated with the industry of the customer, the size of an organization associated with the customer (e.g., a quantity of users, employees, team members, and the like of an organization), the type of products purchased by the customer or similar customers (e.g., customers within the same or a similar industry and associated with organizations of a similar size), a quantity of products purchased by the customer or similar customers, or any combination thereof.

Utilizing this information, a seller agent may be capable of adapting a deal to include additional licenses to a product (e.g., an application, service, a software-as-a-service (SaaS) application, and the like) while maintaining an overall deal price. Additionally, or alternatively, using information from deals of similar customers or the customer, information from the product catalog 260, information from the product documentation 265, or any combination thereof, the pricing system 250 may also be capable of providing the seller agent with recommendations to bundle related products, to provide additional services (e.g., customer support, migration support, and the like), and the like when completing a deal with a customer.

Thus, by utilizing, the pricing system 250 and the subsystem 245, seller agents may be capable of performing more robust and reliable negotiations. Further, in some cases, as described herein, the LLM agent 205-a may be the seller agent and the customer may be the user 230-b or the LLM agent 205-b acting on behalf of the user 230-b. In some examples, in accordance with the techniques of the present disclosure, the LLM agent 205-a and the LLM agent 205-b may be associated with a single trained LLM. In some cases, the LLM may be fine-tuned for specific interactions, such as negotiations (e.g., contract negotiations, product purchase negotiations, and the like). Moreover, in some examples, the LLM may be trained to perform actions for the LLM agent 205-a and the LLM agent 205-b. For example, during runtime, depending on the role, objective, and instructions, the same fine-tuned LLM may be capable of performing actions (e.g., text generation for messages) for the LLM agent 205-a (e.g., the seller agent) or the LLM agent 205-b (e.g., the buyer agent).

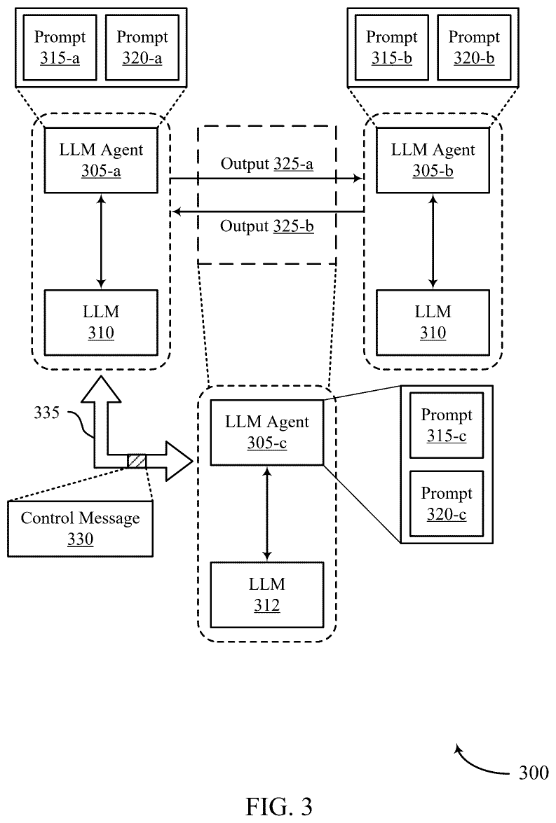

In some examples, the LLM agents 205 may be configured with a first set of parameters for a first LLM prompt and a second set of parameters for a second LLM prompt. An LLM prompt may be a text input that is given to an LLM that provides one or more parameters (e.g., instructions, context, guidelines, configurations, or any combination thereof), to guide or assist the LLM in generating a response and to shape the nature of the output. For example, the first LLM prompt may be referred to as a system prompt that guides an overall role and behavior of an LLM agent 205 and the second LLM prompt may be referred to as a conversation prompt that assists an LLM agent 205 to generate responses in accordance with the latest conversation message. Additionally, or alternatively, the LLM agent 205-b may be configured with, interface with, or interact with a knowledge system 280. In some examples, the knowledge system 280 may be configured with a set of information on an organization or user 230 that the LLM agent 205-b is representing or acting on the behalf of. For example, the LLM agent 205-b may represent or act on the behalf of a manager at an organization that is attempting to purchase a product or service from the LLM agent 205-a (e.g., the user 230 or organization that the LLM agent 205-a is representing or acting on the behalf of). Further descriptions of the LLM agent 205-a and the LLM agent 205-b along with the first set of parameters for the first LLM prompt and the second set of parameters for the second LLM prompt at both the LLM agent 205-a and the LLM agent 205-b may be described elsewhere herein, such as with reference to FIG. 3.

Further, to generate messages and responses, the LLM agent 205-a, the LLM agent 205-b, or both, may use the controller module 210. In some cases, the controller module 210 may be connected to or may interface with an LLM that is associated with both the LLM agent 205-a and the LLM agent 205-b via one or more data flows 240. In some examples, the controller module 210 may be an intermediary and coordinate the flow of messages from the LLM agent 205-a and the LLM agent 205-b. For example, the controller module 210 may obtain, via a data flow 240, a message from the LLM agent 205-a, process the message, and generate an input prompt via the prompt generator 215 for the LLM agent 205-b. Moreover, in some cases, the message obtained from the LLM agent 205-a may be generated using the response assistance module 220. Further, the action assistance module 225 may then assist in interfacing the LLM agents 205 with external tools such as databases, APIs, RAG systems, AI/ML models, and the like.

Thus, the controller module 210 may assist LLM agents 205 in generating messages and generating inputs for LLM agents 205 to generate responses to the messages. For example, a message from the LLM agent 205-a may be used as an input to the LLM agent 205-b such that the LLM agent 205-b can generate a response to the message from the LLM agent 205-a. Further, during interactions, via data flows 240, between the LLM agent 205-a and the LLM agent 205-b, the LLM agent 205-c (e.g., the supervisor agent) may monitor for and intercept the messages from the LLM agent 205-a prior to being output to the LLM agent 205-b. After evaluating the message, the LLM agent 205-c may transmit, via a data flow 240, a control message back to the LLM agent 205-a that includes an indication about the content of the message from the LLM agent 205-a. In some cases, the control message may indicate a positive indication (e.g., the message is in accordance with the instructions of the LLM agent 205-a), a negative indication (e.g., the message violates the instructions of the LLM agent 205-a), or a termination message (e.g., the LLM agent 205 interaction has been terminated). If the LLM agent 205-c outputs a positive indication via the control message, the message from the LLM agent 205-a may be output to the LLM agent 205-b accordingly. Further, if the LLM agent 205-c outputs a negative indication via the control message, the controller module 210 may refrain from providing the message from the LLM agent 205-a to the LLM agent 205-b and may prompt the LLM agent 205-a to regenerate the message.

In some cases, if the regeneration of the message still violates the instructions of the LLM agent 205-a, the LLM agent 205-a may receive another negative indication via a control message from the LLM agent 205-c. Additionally, or alternatively, if the LLM agent 205-c outputs a termination message, the controller module 210 may refrain from providing the message to the LLM agent 205-b and the communications between the LLM agents 205 may be terminated. For example, the computing system 200 may configure the LLM agent 205-c with a threshold quantity of negative indications that can be transmitted via a control message. Thus, after satisfying the threshold quantity of negative indications, if the next generated message fails to be in accordance with the instructions of the LLM agent 205-a, the LLM agent 205-c may transmit the termination indication via a respective control message. In some cases, the LLM agent 205-c may transmit the termination indication based on a conversation or interaction ending. For example, the LLM agent 205-a may transmit a message indicating that the conversation will be continued at a later date or after obtaining additional information and in response the LLM agent 205-c may evaluate the message and determine to end the connection or interaction between the LLM agent 205-a and the LLM agent 205-b after transmission of the message from the LLM agent 205-a. Additionally, or alternatively, a termination indication may also trigger for a human intervention. For example, the user 230-a may intervene for the LLM agent 205-a and the user 230-b may intervene for the LLM agent 205-b.

Further descriptions of the interactions of the LLM agent 205-a, the LLM agent 205-b, and the LLM agent 205-c via one or more data flows 240 may be described elsewhere herein, such as with reference to FIG. 3. For example, FIG. 3 may illustrate an LLM agent 205 communication system and describe the configurations of the LLM agents 205 to interact with each other.

FIG. 3 shows an example of a LLM agent communication system 300 that supports content-based model weight adjustment in accordance with aspects of the present disclosure. In some examples, the LLM agent communication system 300 may implement or be implemented by the system 100, the computing system 200, or both. For example, the LLM agent communication system 300 may include one or more LLM agents 305 (e.g., an LLM agent 305-a, an LLM agent 305-b, an LLM agent 305-c) that may be implement or be implemented by corresponding devices or services described herein with reference to FIG. 1, such as the generative AI component 145. Further, the LLM agents 305 may be associated with or may correspond with an LLM 310 that the LLM agents 305 can utilize to perform one or more actions as described elsewhere herein.

In some examples of the LLM agent communication system 300, the LLM agent 305-a and the LLM agent 305-b may communicate or interact with each other. For example, the LLM agent 305-a and the LLM agent 305-b may be negotiator agents that negotiate contracts on the behalf of users. Further the LLM agent 305-a and the LLM agent 305-b may be based on the LLM 310 which may be finetuned to perform one or more operations and to generate content for negotiator agents. In some cases, as described elsewhere herein, the LLM agent 305-a may be a seller agent that is configured to perform the role of a salesperson and the LLM agent 305-b may be a buyer agent that represents a customer interested in purchasing goods or service from the seller agent. Further, the LLM agent 305-c may be a supervisory agent that is configured to monitor the interactions (e.g., negotiation conversation) between the LLM agent 305-a and the LLM agent 305-b to ensure that one or more guidelines are followed and to provide course corrections. For example, if the LLM agent 305-a, the LLM agent 305-b, or both, violate a guideline or instruction, the LLM agent 305-c may have the respective LLM agent 305 regenerate a message or the LLM agent 305-c may call for human intervention. In some cases, human intervention may be called based on the LLM agent 305-a being unable to regenerate a message that is in accordance with a set of guidelines or instructions. Additionally, or alternatively, the LLM agent 305-c may also terminate the interaction based on multiple course corrections being indicated to the LLM agent 305-a (e.g., the LLM agent 305-a generated multiple messages that violated one or more guidelines or instructions).

Further, the LLM agent 305-a and the LLM agent 305-b may be configured with a first set of parameters for an LLM prompt 315 (e.g., a first LLM prompt) and a second set of parameters for an LLM prompt 320 (e.g., a second LLM prompt). In some cases, the LLM prompt 315 may be a system prompt that indicates the role of an LLM agent 305 and instructions for the runtime behavior of the LLM agent 305 and the LLM prompt 320 may be a conversation prompt. Thus, the LLM agent 305-a and the LLM agent 305-b may generate message by utilizing the instructions of the LLM prompt 315 and the latest conversation history indicated via the LLM prompt 320. Further, the LLM agent 305-a and the LLM agent 305-b may generate message in accordance with a role, scenario, objection, and a current context in an interaction (e.g., a negotiation). Moreover, the LLM prompt 315 may ensure that the messages are within a professional tone and refrain from displaying any negative elements such as anger, frustration, bias, toxicity, and the like.

Therefore, in accordance with the techniques of the present disclosure, the LLM agent 305-a and the LLM agent 305-b may use the LLM prompt 315 and the LLM prompt 320 to generate messages and responses. For example, the LLM prompt 315 may include session level settings such as an agent scenario, role, goals and guardrails to guard against bias, toxicity, and the like, or any combination thereof. Thus, the LLM prompt 315 may guide the overall role and behavior of the LLM agent 305. The LLM prompt 320 may include a recent conversation history along with bookkeeping to mark a session offset and a cue for a next message to assist the LLM agents 305 in generating a response in accordance with the latest conversation messages. Moreover, the LLM prompt 320 may be input with messages from the LLM agent 305-c, information (e.g., pricing and product information) from a pricing agent (e.g., a configure, price, and quote (CPQ) agent), or both. That is, an output 325 from a respective LLM agent 305 may be input into the LLM prompt 320 of the other LLM agent 305. For example, the output 325-a from the LLM agent 305-a (e.g., a message for the LLM agent 305-b) may be input into the LLM prompt 320-b of the LLM agent 305-b. Similarly, the output 325-b from the LLM agent 305-b (e.g., a message for the LLM agent 305-a and in response to the output 325-a) may be input into the LLM prompt 320-a of the LLM agent 305-a. Therefore, the LLM agents 305 may use the previous messages and conversation as input to the LLM 310 to generate subsequent response messages

In some cases, the first set of parameters for the LLM prompt 315 (e.g., the system prompt) may include a scenario parameter, a role parameter, a goal parameter, and a set of instructions. For example, in the case of contract negotiations, the scenario parameter may indicate an overall setting of a negotiation, details or information associated with a buyer and seller and a corresponding organization, information about what the contract is for, and the like. Further, the role parameter may be used to assign a role that the LLM agent 305 is performing. For example, the LLM agent 305-a may be a seller and the LLM agent 305-b may be a buyer. Moreover, the role parameter may also indicate information associated with a user that the respective LLM agent 305 is acting on the behalf of, skills associated with user or role, expertise and domain knowledge of the agent that is relevant to the negotiation, or any combination thereof. Further, the goals parameter may assign an overall goal for the LLM agent 305. For example, the goal parameter may indicate a recommended priced to quote, a minimum price to negotiate, whether an agent should terminate a negotiation of a deal if a minimum price is not met, and the like. Moreover, the set of instructions of the LLM prompt 315 may indicate one or more guardrails for the generation of messages such as the messages should be only from the perspective of the assigned role of the LLM agent 305, instructions against bias, harmful, abusive, or toxic content, and the like. Thus, the LLM prompt 315 may set up an initial set of guidelines and behaviors for the respective LLM agents 305. Additionally, or alternatively, as the LLM agent 305-a and the LLM agent 305-b may have different roles and goals to obtain, the LLM agent 305-a may be configured with a first set of parameters for the LLM prompt 315-a and the LLM agent 305-b may be configured with a first set of parameters for an LLM prompt 315-b that are different from the first set of parameters for the LLM prompt 315-a at the LLM agent 305-a.

Further, the LLM agent 305-a and the LLM agent 305-b may be configured with a LLM prompt 320 (e.g., a LLM prompt 320-a for the LLM agent 305-a and a LLM prompt 320-b for the LLM agent 305-b) that is a conversation prompt. In some cases, a second set of parameters for the LLM prompt 320 may include a session position indicator parameter, an agent messages parameter, and a parameter to indicate a cue for a next message. The session position indicator parameter of the LLM prompt 320 may include two values, a session start value and a truncated session value. The session start value may be a token to indicate a start of a session (e.g., a conversation session between the LLM agent 305-a and the LLM agent 305-b) that is used to help orient the LLM agents 305 and cue the LLM agents 305 to initiate a conversation. The truncated session value may be a token that is used to indicate that the session has been truncated to fit the conversation history into the context window of the LLM 310. A context window may represent a quantity of tokens (e.g., a maximum quantity of words, word pieces, characters, and the like) that a respective LLM 310 can process and consider at once during both input and generation. For example, the context window may act as a working memory for an LLM 310 for understanding and maintaining coherence across relatively long portions of text or conversation. Thus, as the conversation between the LLM agent 305-a and the LLM agent 305-b may be relatively long, the LLM prompt 320 may include a truncated version of the conversation, and the truncated session value may indicate that the session is truncated.

The agent messages parameter may indicate a conversation history of the messages exchanged by the LLM agents 305. In some cases, the conversation history included within the LLM prompt 320 may be a full version of the conversation history or a truncated version as indicated by the truncated session token of the session position indicator parameter. In some examples, if the conversation history is truncated, the agent messages parameter may also include a brief summary of the messages left out of the truncated conversation history to ensure that the LLM agents 305 can generate accurate and reliable messages. For example, if the LLM agent 305-a transmits a message to the LLM agent 305-b that is associated with a previous message that is not included within the truncated conversation history, by using the message summary, the LLM agent 305-b may be capable of generating an accurate and reliable response. Further, the parameter to indicate a cue for a next message may be an indicator used to denote that the current LLM agent 305 has stopped conversing and that the other LLM agent 305 can converse. For example, if the parameter indicated a value of “<seller>,” the parameter may indicate that a message from the buyer agent (e.g., the LLM agent 305-b) has finished and the seller agent (e.g., the LLM agent 305-a) may transmit a message in response. Moreover, a value of “<buyer>” may indicate that a message from the seller agent has finished and the buyer agent may transmit a message in response. Additionally, or alternatively, the second set of parameters for an LLM prompt 320-a at the LLM agent 305-a may be different than the second set of parameters for an LLM prompt 320-b at the LLM agent 305-b. Thus, during an interaction or conversation session (e.g., a negotiation session), the LLM agent 305-a may utilize the first set of parameters of the LLM prompt 315-a and the second set of parameters of the LLM prompt 320-a and the LLM agent 305-b may utilize the first set of parameters of the LLM prompt 315-b and the second set of parameters of the LLM prompt 320-b.

Further, in some cases, the messages generated by the LLM agent 305-a, the LLM agent 305-b, or both may include incorrect or undesired content. Thus, in accordance with the techniques of the present disclosure, the LLM agent 305-c may be used to implement a mechanism for detecting the incorrect or undesired messages. For example, during interactions between the LLM agent 305-a and the LLM agent 305-b, to ensure that messages from the LLM agent 305-a are in accordance with the LLM prompt 315-a at the LLM agent 305-a the LLM agent 305-c may transmit control messages 330 during the interaction. For example, the LLM agent 305-a may transmit a first message that includes a first set of content that is generated based on the first set of parameters of the LLM prompt 315-a and the second set of parameters of the LLM prompt 320-a. In response, the LLM agent 305-c may monitor the first message and transmit a control message 330 to the LLM agent 305-a via a communication link 335. The control message 330 may include an indication that is based on the first set of content of the first message. In some cases, if the first set of content of the first message is in accordance with the LLM prompt 315-a, the indication of the control message 330 may be a positive indication. In some other cases, if the first set of content of the first message violates a configuration indicated by the LLM prompt 315-a, the indication of the control message 330 may be a negative indication. In another case, if the first set of content of the first message indicates that a conversation has ended or if human intervention is expected, the indication of the control message 330 may be a termination indication. In some cases, human intervention may be expected based on the LLM agent 305-c transmitting multiple control messages 330 with negative indications in a row (e.g., a quantity of control messages 330 that satisfies a threshold quantity). In some other cases, human intervention may be expected based on the first set of content. For example, if the first set of content indicates that an approval from a manager is needed, the LLM agent 305-c may trigger for a human intervention.

To generate the control messages and to monitor the interactions of the LLM agents 305 (e.g., the LLM agent 305-a and the LLM agent 305-b), the LLM agent 305-c may be configured with an LLM prompt 315-c and an LLM prompt 320-c. In some cases, the LLM prompt 315-c may be a system prompt for the LLM agent 305-c that includes the session level or static instructions for the LLM agent 305-c. For example, the LLM prompt 315-c may include a set of supervisor instructions, a set of negotiator instructions, indications of one or more monitoring message types, or any combination thereof. The set of supervisor instructions may be a set of high level instructions that describe the role of the LLM agent 305-c. For example, the set of supervisor instructions may indicate which LLM agents 305 that the LLM agent 305-c has to monitor the conversation of, which LLM agent 305 (e.g., the LLM agent 305-a) that the LLM agent 305-c is a supervisor of, and the like. The set of negotiator instructions may indicate the instructions of the LLM agent 305 that the LLM agent 305-c is the supervisor for. For example, when configured to monitor the messages from the LLM agent 305-a, the LLM agent 305-c may be configured with the first set of parameters of the LLM prompt 315-a at the LLM agent 305-a. Further, the indications of the one or more monitoring message types may indicate the different types of messages that the LLM agent 305-c is configured to output and the usage of the respective messages. For example, as described elsewhere herein, the LLM agent 305-c may transmit a control message that can include a positive indication, a negative indication, or a termination indication.

Moreover, the LLM prompt 320-c may be considered a conversation prompt that includes the latest conversation history for the LLM agent 305-c to monitor. In some examples, the LLM prompt 320-c may be configured with a set of agent messages and a cue for supervisor parameter. The set of agent messages may include one or more messages exchanged by the LLM agents 305 where the last message included within the set is from the LLM agent 305 (e.g., the LLM agent 305-a) that the LLM agent 305-c is monitoring. Further, the cue for supervisor parameter may be an indicator used to denote that the LLM agents 305 have stopped conversing and that the LLM agent 305-c should monitor the set of agent messages to output a control message based on the set of content of the latest message.

In some examples, based on monitoring the content of the latest message, the LLM agent 305-c may output a control message that includes a positive indication. In some cases, a control message that includes the positive indication may also be referred to as a supervisor ok message and can be used when the LLM agent 305-a has generated a message in accordance with the guidelines of the LLM prompt 315-a at the LLM agent 305-a. Moreover, in some cases, during implementation, the LLM agent 305-a and the LLM agent 305-b may be trained and configured to ignore such messages. For example, after each message from the LLM agent 305-a, the LLM agent 305-c may transmit a control message 330 and if the control message is a supervisor ok message, a controller module (e.g., the controller module 210 described with reference to FIG. 2) may obtain the control message, output the message from the LLM agent 305-a to the LLM agent 305-b, and trigger the LLM agent 305-b to generate a response. Thus, the controller module may refrain from outputting the control message 330 to the LLM agent 305-a if the control message 330 includes a positive indication. Further, in some other examples, based on monitoring the content of the latest message, the LLM agent 305-c may output a control message 330 that includes a termination message. In some cases, the termination indication may also be referred to as an end session message that the LLM agent 305-c can use to signal the end of a conversation to the LLM agents 305 (e.g., the LLM agent 305-a and the LLM agent 305-b). Moreover, based on receiving the termination indication, the LLM agents 305 may output an appropriate termination message (e.g., a goodbye message) and interaction between the LLM agents 305 will be terminated.

In another example, based on monitoring the content of the latest message, the LLM agent 305-c may output a control message that includes a negative indication. In some cases, the negative indication may be referred to as a course correct message that the LLM agent 305-c can use to indicate that the LLM agent 305-a is violating a configuration indicated via the LLM prompt 315-a at the LLM agent 305-a. Further, when the LLM agent 305-c transmits such control message, the controller module (e.g., the controller module 210 described with reference to FIG. 2) may obtain the control message, refrain from outputting the message from the LLM agent 305-a, and output the control message to the LLM agent 305-a. Moreover, when the LLM agent 305-c transmits the control message 330 in response to monitoring a first message from the LLM agent 305-a that includes a first set of content generated by the LLM prompt 315-a at the LLM agent 305-a, the control message 330 may include a trigger for the LLM agent 305-a to generate a second set of content for the first message. Further, in response to the LLM agent 305-a receiving the course correct message, the LLM agent 305-a may be trained to switch the set of parameter weights that are applied to the LLM 310 associated with the LLM agent 305-a to ensure that the second set of content is generated in accordance with the LLM prompt 315-a at the LLM agent 305-a.

For example, when the LLM agent 305-a receives a negative indication via the control message 330 (e.g., a course correct message), an LLM service controlling the LLM agents 305 (e.g., the controller module 210 described with reference to FIG. 2) may switch from applying a first set of parameter weights to the LLM 310 associated with the LLM agent 305-a to applying a second set of parameter weights to the LLM 310, where the first set of parameter weights are different from the second set of parameter weights. By applying the second set of parameter weights to the LLM 310, the LLM agent 305-a may be configured to follow the first set of parameters of the LLM prompt 315-a relatively more closely. For example, when the LLM agent 305-c transmits a negative indication via the control message 330 in response to a first message from the LLM agent 305-a, the LLM agent 305-c may prevent the first message from being transmitted. That is, an LLM service may refrain from transmitting the first message from the LLM agent 305-a to the LLM agent 305-b based on the first set of content of the first message violating a configuration indicated via the LLM prompt 315-a at the LLM agent 305-a and the LLM agent 305-c transmitting a control message 330 that includes a negative indication. Further, based on receiving the control message 330 with the negative indication, the LLM agent 305-a may be triggered to regenerate the first message using the LLM 310 with the second set of parameter weights applied.

In some examples, to obtain the first set of parameter weights and the second set of parameter weights, the LLM agent 305-a and the LLM agent 305-b may undergo a training procedure prior to configuration and deployment of the LLM agents 305. For example, the LLM 310 of the LLM agent 305-a and the LLM agent 305-b may be trained to work with the LLM prompt 315 and the LLM prompt 320 and the LLM agents 305 may be trained to weight control messages from the LLM agent 305-c that include with negative indications differently. Thus, the training procedure may enable the LLM agents 305 to obtain the first set of parameter weights to apply during normal operation and to obtain the second set of parameter weights to apply to the LLM 310 based on receiving a negative indication via a control message 330.

In some cases, LLMs may have a relatively large quantity of parameter weights that store knowledge associated with the LLM 310 and can be used to determine how the LLM 310 should process input tokens. Further, in some examples, the parameter weights may be adjusted and configured during training to capture patterns and relationships in language to enable the LLM 310 to generate contextually appropriate responses. Therefore, in accordance with the techniques of the present disclosure during a training procedure for the LLM agent 305-a and the LLM agent 305-b, a base model (e.g., the LLM 310) may be trained on data for performing a respective task (e.g., the LLM 310 is trained on contract negotiation data). In some cases, such training may be performed using a supervised finetuned loss on a labeled training dataset (e.g., a labeled negotiation training dataset).

The training procedure may also ensure that the content generated by the LLM agents 305 refrain from diverging away from the base model of the LLM 310. For example, the base model of the LLM 310 may be an example of an LLM 310 that is tuned on a set of instructions to ensure that the LLM 310 is capable of following instructions and outputting bias and toxicity free responses. Further, in some cases, the base model used for the LLM 310 that is utilized by the LLM agent 305-a and the LLM agent 305-c may be an example of an instruction tuned model (e.g., LLM) that is trained with reinforcement learning from human feedback (RLHF) to follow human instructions. Moreover, in addition to being trained to follow human instructions, the base model may also be trained to generate accurate and honest responses that avoids hallucinations and refrains from including any harmful, toxic, or biased information within the responses. For example, in some cases, LLMs may “hallucinate” by generating plausible-sounding information that is false and inaccurate. In some cases, LLMs may hallucinate based on performing a statistical pattern matching that produces a text sequence that diverges from a factual reality. Further, while such models may be efficient and reliable for general text generations, when using the LLMs for a specific task, the LLMs should be further finetuned to perform the respective task.

Therefore, when finetuning the LLM 310, the LLM 310 may be finetuned to perform respective tasks (e.g., such as text generation for content negotiation) while maintaining the general characteristics of the base model as described herein. For example, in accordance with the techniques of the present disclosure, the training phase of the LLM agent 305-a and the LLM agent 305-b may include generating a penalty term in the loss which is based on a Kullback-Leibler (KL) divergence between the LLM 310 that is finetuned for the LLM agent 305-a and the LLM agent 305-b and the based model of the LLM 310. In some examples, a KL divergence may be a mathematical measure that quantifies a difference of two probability distributions. That is, the LLM 310 may be finetuned to ensure that the LLM agents 305-a and the LLM agent 305-b are capable of being used for a respective task (e.g., contract negotiation) while refraining from diverging from the behaviors the LLM 310 is already configured with. Moreover, the training procedure may also ensure that LLM agents 305 may follow the indication of a control message from the LLM agent 305-c. For example, to ensure that the LLM agent 305-a follows and listens to the control message from the LLM agent 305-c a weight term may be added to the serviced training loss when the input message to the LLM agent 305-a is from the LLM agent 305-c.

Therefore, as part of the training procedure (e.g., the finetuning of the LLM 310), a negotiator agent loss parameter may be generated as illustrated in Equations 1 through 3 below. In such equations, N may indicate a quantity of samples in an LLM agent 305 training dataset. For example, training the LLM agent 305-a, the LLM agent 305-b, and the LLM agent 305-c may include using a set of training data that includes one or more system messages, a session position indicator, one or messages from the LLM agent 305-a, the LLM agent 305-b, the LLM agent 305-c, or any combination thereof, a cue for next message indication, a termination message from the LLM agent 305-c, or any combination thereof. Further, each training sample may include an input and output pair (e.g., an <input_sequence>, <output_sequence> pair). Moreover, each input (e.g., <input_sequence>) may be a prompt for the LLM agent 305 and each output (e.g., <output_sequence>) may be the response from the LLM agent 305. Further,

$${T}_{n}^{x}$$

may indicate a quantity or tokens in the input (e.g., <input_sequence>) training data sample n and

$${T}_{n}^{y}$$

may indicate a quantity of tokens in the output (e.g., <output_sequence>) training data sample n. Further, Xₙ may indicate a vector representing the input token sequence in training data sample

$$n ( e . g . , {X}_{n} = [ {x}_{n , 1} , {x}_{n , 2} , … , {x}_{n , {T}_{n}^{x}} ] )$$

and Yₙ may indicate a vector representing the output token sequence in training data sample

$$n ( e . g . , {Y}_{n} = [ {y}_{n , 1} , {y}_{n , 2} , … , {y}_{n , {T}_{n}^{y}} ] ) .$$

Moreover, π_{base} may indicate a set of parameters of the base instruction tuned LLM which is finetuned on the negotiator training dataset and π_{neg} may indicate a set of parameters of the finetuned LLM agent model (e.g., the LLM 310).

Additionally, or alternatively, as illustrated via the below equations, to obtain the second set of parameter weights, the training procedure may include adjusting a first weight of at least one parameter weight of the second set of parameter weights of the LLM to be associated with the control message 330. For example, α may be a configurable weight term to teach the LLM 310 of the LLM agent 305-a to place a higher importance on control messages 330 that include negative indications. Further, the training procedure may also include adjusting a second weight of at least one parameter weight of the second set of parameter weights of the LLM to be associated with a base set of parameters (e.g., π_{base}) and a finetuned set of parameters (e.g., π_{neg}) associated with a first set of parameters of the LLM prompt 315-a. For example, β may be a weight term which penalizes the training loss when the negotiator model parameters, π_{neg}, diverge relatively too far from the parameters, π_{base}, of the base model.

$$L ( \text{} {π}_{neg} ) = \text{} - [ \text{} {\sum }_{n = 1}^{N} α \text{} {\sum }_{t = 1}^{{T}_{n}^{y}} log \text{} ( P ( {y}_{n , t + 1} \vert {X}_{n} , {y}_{n , 1} , {y}_{n , 2} , … , {y}_{n , t} ) ) ] \qquad ( 1 )$$

$$- \text{} [ β \text{} {\sum }_{n = 1}^{N} {D}_{K L} ( {π}_{n e g} ‖ {π}_{b a s e} ) ]$$

$$α = \{ \begin{matrix}< 1 & if {X}_{n} is a supervisor message \\ 1 , & otherwise\end{matrix} \qquad ( 2 )$$

$${D}_{K L} ( {π}_{n e g} ‖ {π}_{b a s e} ) = log ( \frac{P ( {Y}_{n} \vert {X}_{n} , {π}_{n e g} )}{P ( {Y}_{n} \vert {X}_{n} , {π}_{b a s e}} ) \qquad ( 3 )$$

As shown in Equation 1, the loss includes two terms. The first loss term minimizes the negative log likelihood of generating LLM agent 305 response from the LLM 310, given the input prompt and the sequence generated so far. This is then summed over the entire training dataset that includes both messages between the LLM agent 305-a and the LLM agent 305-b and messages between the LLM agent 305-a and the LLM agent 305-c. The first term is also weighted by a which controls the penalty incurred for not generating the correct responses to a control message 330 that includes a negative indication (e.g., the course correct messages). The second term is a measure of the KL divergence between the output distribution of the finetuned negotiator model (e.g., the LLM 310) and the base model (e.g., a model that the LLM 310 is based on). The KL term is then weighted by β and can be used to control the divergence of π_{neg} from π_{base}.

In some examples, training of the LLM agent 305-c may include focusing on training an LLM 312 associated with the LLM agent 305-c to output a positive indication most of the times and a negative indication when the LLM agent 305-c detects an error or configuration violation within a respective message from the LLM agent 305-a. For example, the LLM 312 may be input the current conversation between the LLM agent 305-a and the LLM agent 305-c and the LLM agent 305-c may be configured to verify if the last message from the LLM agent 305-a is in accordance with the LLM prompt 315-a at the LLM agent 305-a (e.g., if the message is per the guardrails and instructions of the LLM agent 305-a). Therefore, as part of the training procedure (e.g., the finetuning of the LLM 312), a supervisor agent loss parameter may be generated as illustrated in Equations 4 through 7 below. In such equations, M may indicate a quantity of samples in a supervisor agent training dataset (e.g., a training dataset for training the LLM agent 305-c). In some cases, each training sample may include an input (e.g., <input_sequence>) and output (e.g., <output_sequence>) pair (e.g., (<input_sequence>, <output_sequence>)). Further, the input may be the prompt for the LLM agent 305-c and the output may be the response from the LLM agent 305-c. Further,

$${T}_{m}^{x s}$$

may indicate a quantity of tokens in the input (e.g., <input_sequence>) training data sample m and

$${T}_{m}^{y s}$$

may indicate a quantity of tokens in the output (e.g., <output_sequence>) training data sample m. Further, XSₘ may indicate a vector representing the input token sequence in training data sample

$$m ( e . g . , {XS}_{m} = [ {xs}_{m , 1} , {xs}_{m , 2} , … , {xs}_{m , {T}_{m}^{xs}} ] )$$

and YSₘ may indicate a vector representing the output token sequence in training data sample

$$m ( e . g . , {YS}_{m} = [ {ys}_{m , 1} , {ys}_{m , 2} , … , {ys}_{m , {T}_{m}^{ys}} ] ) .$$

Moreover, π_{base} may indicate a set of parameters of the base instruction tuned LLM which is finetuned on the supervisor training dataset and πₛᵤₚ may indicate a set of parameters of the finetuned supervisor agent (e.g., the LLM agent 305-c) model (e.g., the LLM 312).

Additionally, or alternatively, as illustrated via the below equations, γ may be a configurable weight term that is used to assist the LLM 312 in detecting incorrect messages from the LLM agent 305-a and generate a control message 330 with a negative indication (e.g., course correct responses). Further, η may indicate a weight term that penalizes the supervisor model (e.g., the LLM 312) when the parameters, πₛᵤₚ, of the LLM 312 diverge relatively far away from the parameters, π_{base}, of the base model (e.g., a model that the LLM 312 is based on). Thus, the supervisor loss may be expressed via Equations 4 through 7.

$$L ( {π}_{sup} ) = \text{} - [ {\sum }_{m = 1}^{M} γ \text{} {\sum }_{t = 1}^{{T}_{m}^{y s}} log ( \text{} P ( \text{} {ys}_{m , t + 1} \vert X {S}_{m} , {ys}_{m , 1} , {ys}_{m , 2} , … , {ys}_{m , t} ) ) ] \qquad ( 4 )$$

$$- \text{} [ η \text{} {\sum }_{m = 1}^{M} {D}_{K L} ( \text{} {π}_{sup} ‖ {π}_{b a s e} ) ]$$

$${T}_{m}^{y s} = \{ \begin{matrix}1 , & if {XS}_{m} is a correct LLM agent message \\ > 1 , & if {XS}_{m} is an incorrect LLM agent message\end{matrix} \qquad ( 5 )$$

$$γ = \{ \begin{matrix}< 1 , & if {XS}_{m} is an input denoteing an incorrect response \\ 1 , & otherwise\end{matrix} \qquad ( 6 )$$

$${D}_{K L} ( {π}_{sup} ‖ {π}_{b a s e} ) = log ( \frac{P ( {YS}_{m} \vert {XS}_{m} , {π}_{sup} )}{P ( {YS}_{m} \vert {XS}_{b} , {π}_{b a s e}} ) \qquad ( 7 )$$

As such,

$${T}_{m}^{y s}$$

being equal to i may indicate a control message 330 with a positive indication and a value of less than 1 may indicate that a control message 330 with a negative indication is expected. Further, if the γ weight term is less than 1, then an incorrect message was received from the LLM agent 305-a (e.g., the LLM agent 305-c receives a message from the LLM agent 305-a that includes a set of content that violates a configuration indicated via the LLM prompt 315-a of the LLM agent 305-a). Additionally, or alternatively, such training procedure as described herein in accordance with the techniques of the present disclosure may enable for training the LLM agents 305 independently (e.g., both the LLM agent 305-a and the LLM agent 305-b may be trained independent from the LLM agent 305-c). For example, based on using training datasets that ensures an interplay of different message types, the LLM agents 305 may be able to be trained independently. Thus, the training procedure described herein may result in a reduction in the complexity and time consumption of training the LLM agents 305. For example, joint training of multiple models (e.g., the LLM 310 and the LLM 312) may be relatively complex and convergence may be difficult to achieve. In some cases, when training the LLM 310 and the LLM 312 jointly, the behavior of the LLMs may affect each other resulting in a relatively long training procedure that includes multiple retraining steps. However, based on generating training datasets for both training the LLM agent 305-a and the LLM agent 305-b and training the LLM agent 305-c, the LLM agents 305 may be trained independently resulting in a relatively faster deployment which can also result in an increase in efficiency and reliability of the LLM agent communication system 300.

Moreover, it should be understood that while FIG. 3 illustrates the LLM agent 305-c transmitting control messages to the LLM agent 305-a, the LLM agent 305-c may also monitor the messages from the LLM agent 305-b and transmit one or more control messages 330 to the LLM agent 305-b. Thus, the LLM agent 305-c may be implemented and configured to monitor the messages of the LLM agent 305-a, the LLM agent 305-b, or both.

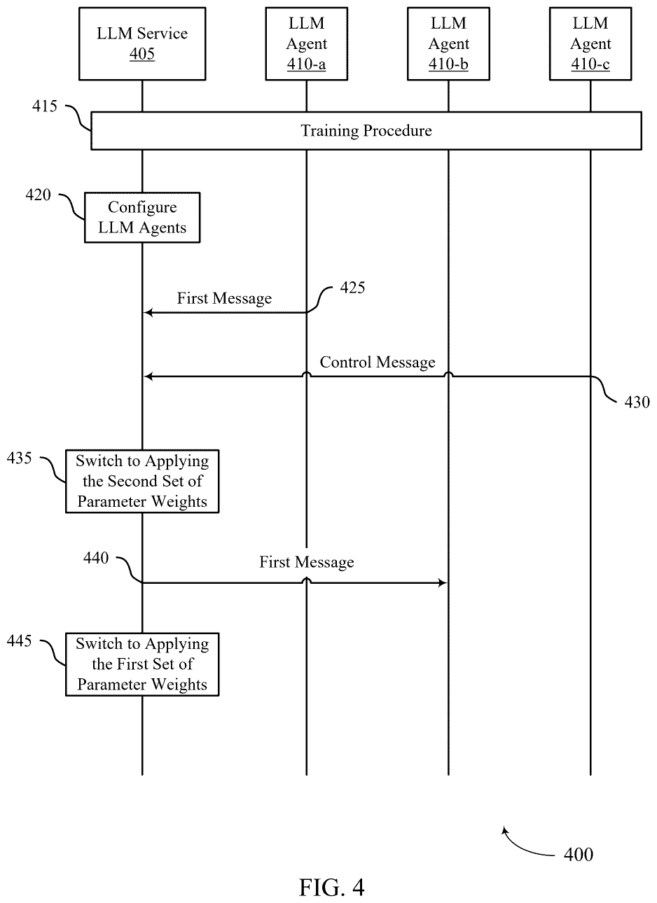

Further descriptions of the techniques of the present disclosure may be described elsewhere herein. For example, further descriptions of the LLM agent 305 interactions, the training procedure of the LLM agents 305, and the like to ensure that the LLM agent communication system 300 is efficient and reliable in accordance with the techniques of the present disclosure may be described elsewhere herein, such as with reference to FIG. 4.

FIG. 4 shows an example of a process flow 400 that supports content-based model weight adjustment in accordance with aspects of the present disclosure. In some aspects, the process flow 400 may implement or may be implemented by the system 100, the computing system 200, the LLM agent communication system 300, or any combination thereof. The process flow 400 may include an LLM service 405, an LLM agent 410-a, an LLM agent 410-b, and an LLM agent 410-c, which may be examples of devices or services described elsewhere herein including with reference to FIGS. 1 through 3.

In the following description of the process flow 400, the operations may be performed by the LLM service 405, the LLM agent 410-a, the LLM agent 410-b, and the LLM agent 410-c in different orders or at different times. Some operations may also be left out of the process flow 400 or other operations may be added. Although the process flow 400 may be described as being performed by the LLM service 405, the LLM agent 410-a, the LLM agent 410-b, and the LLM agent 410-c, some aspects of some operations may also be performed by other devices, services, or models described elsewhere herein including with reference to FIGS. 1 through 3.

At 415, prior to configuring LLM agent 410-a, LLM agent 410-b, and LLM agent 410-c, the LLM service 405 may perform a training procedure to obtain a first set of parameter weights and a second set of parameter weights to apply to an LLM associated with LLM agent 410-a. In some examples, as part of performing the training procedure, the LLM service 405 may adjust a first parameter weight of the second set of parameter weights of the LLM to be associated with a control message comprising a negative indication and a second parameter weight of the second set of parameter weights of the LLM to be associated with a fine-tuned set of parameters for the LLM associated with LLM agent 410-a diverging from a base set of parameters for the LLM. Further, obtaining the second set of parameter weights may be based on adjusting the first parameter weight and the second parameter weight, and the first parameter weight and the second parameter weight may be associated with a loss parameter applied to the LLM associated with LLM agent 410-a. Further, in some examples, as part of the training procedure, the LLM service 405 may train the LLM agent 410-a, LLM agent 410-b, and LLM agent 410-c using a set of training data that includes one or more system messages, a session position indicator, one or messages from LLM agent 410-a, LLM agent 410-b, LLM agent 410-c, or any combination thereof, a cue for next message indication, a termination message from LLM agent 410-c, or any combination thereof. Thus, obtaining the second set of parameter weights may be based on training LLM agent 410-a, LLM agent 410-b, and LLM agent 410-c using the set of training data.

At 420, the LLM service 405 may configure the LLM agent 410-a and LLM agent 410-b with a first set of parameters for a first LLM prompt and a second set of parameters for a second LLM prompt that are different for LLM agent 410-a and LLM agent 410-b. In some examples, the first set of parameters for the first LLM prompt may include a scenario parameter, a role parameter, a goal parameter, and an instructions parameter, or any combination thereof. Further, the second set of parameters for the second LLM prompt may include a session position indicator parameter, a messages parameter indicating one or messages from LLM agent 410-a and LLM agent 410-b, a cue for next message parameter, or any combination thereof. Moreover, the LLM service 405 may configure the LLM agent 410-c with the first set of parameters for the first LLM prompt at LLM agent 410-a in response to configuration of LLM agent 410-a.

At 425, the LLM service 405 may obtain, from LLM agent 410-a, a first message that includes a first set of content that is generated based on the first set of parameters for the first LLM prompt at LLM agent 410-a and the second set of parameters for the second LLM prompt at LLM agent 410-a.

At 430, the LLM service 405 may obtain, from the LLM agent 410-c, a control message that includes an indication based on the first set of content of the first message. In some examples, obtaining the control message may involve receiving a positive indication via the indication of the control message, a negative indication via the indication of the control message, or a termination indication via the indication of the control message where the type of indication is based on the first set of content of the first message. In some cases, the indication of the control message may include the positive indication based on the first set of content of the first message being in accordance with the first LLM prompt at the LLM agent 410-a and the indication of the control message may include the negative indication based on the first set of content of the first message violating a configuration indicated by the first LLM prompt at the LLM agent 410-a. Further, in some cases, in response to the control message from the LLM agent 410-c, the LLM service 405 may refrain from outputting the first message to the LLM agent 410-b based on the indication of the control message. For example, if the indication of the control message is a negative indication, the LLM service 405 may refrain from outputting the first message from the LLM agent 410-a to the LLM agent 410-b.

At 435, in response to obtaining the control message from the LLM agent 410-c and based on the indication of the control message, the LLM service 405 may switch from applying a first set of parameter weights to an LLM associated with the LLM agent 410-a to applying a second set of parameter weights to the LLM, where the first set of parameter weights are different from the second set of parameter weights. In some cases, the LLM service 405 may output the control message to the LLM agent 410-a, where switching from applying the first set of parameter weights to the LLM to applying the second set of parameter weights to the LLM is based on outputting the control message. Additionally, or alternatively, based on the LLM agent 410-a obtaining a control message that includes a negative indication, the LLM agent 410-a may be triggered to generate an additional set of content for the first message. Thus, in some examples the LLM service 405 may obtain, from the LLM agent 410-a, the first message that includes a second set of content that is generated based on the first set of parameters for the first LLM prompt at the LLM agent 410-a and the second set of parameters for the second LLM prompt at the LLM agent 410-a. The second set of content of the first message may be based on the first set of content, where the second set of content is generated in accordance with the second set of parameter weights being applied to the LLM. Further, in response to obtaining the first message with the second set of content, the LLM service 405 may obtain, from the LLM agent 410-c, a second control message that includes a second indication based on the second set of content of the first message. In some cases, if the second set of content is in accordance with the first set of parameters of the first LLM prompt at the LLM agent 410-a, the second control message may include a positive indication. In some other cases, if the second set of content is in violation of a configuration indicated via the first LLM prompt at the LLM agent 410-a, the second control message may include a negative indication.

At 440, the LLM service 405 may output, to the LLM agent 410-b, the first message obtained from the LLM agent 410-a based on the indication of the control message and switching to applying the second set of parameter weights to the LLM. In some examples, the LLM service 405 may output the first message obtained from the LLM agent 410-a to the LLM agent 410-b based on the second indication of the second control message and the second set of parameter weights being applied to the LLM. For example, the LLM service 405 may output the first message to the LLM agent 410-b based on a respective control message indicating a positive indication. Further, switching from applying the second set of parameter weights to the LLM to applying the first set of parameter weights to the LLM may be based on outputting the first message and obtaining the second control message. Additionally, or alternatively, in response to outputting the first message, the LLM service 405 may update the second set of parameters for the second LLM prompt at both the LLM agent 410-a and the LLM agent 410-b. Updating the second set of parameters for the second LLM prompt at the LLM agent 410-b may involve providing the first message as an input to the LLM agent 410-b. Thus, at 445, in response to outputting the first message, the LLM service 405 may switch from applying the second set of parameter weights to the LLM associated with the LLM agent 410-a to applying the first set of parameter weights to the LLM.

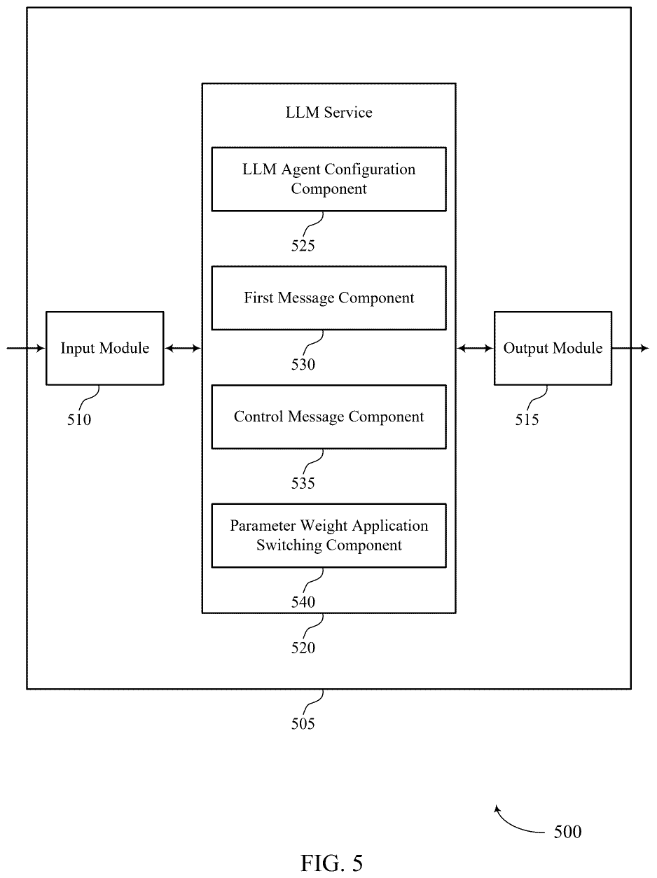

FIG. 5 shows a block diagram 500 of a device 505 that supports content-based model weight adjustment in accordance with aspects of the present disclosure. The device 505 may include an input module 510, an output module 515, and an LLM service 520. The device 505, or one or more components of the device 505 (e.g., the input module 510, the output module 515, the LLM service 520), may include at least one processor, which may be coupled with at least one memory, to support the described techniques. Each of these components may be in communication with one another (e.g., via one or more buses).

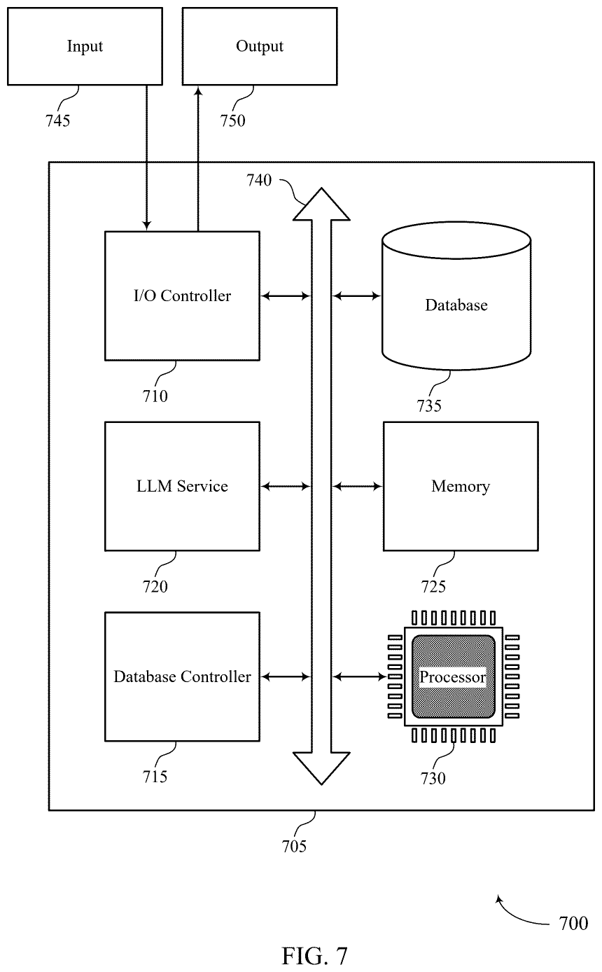

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the LLM service 520 to support content-based model weight adjustment. In some cases, the input module 510 may be a component of an input/output (I/O) controller 710 as described with reference to FIG. 7.

The output module 515 may manage output signals for the device 505. For example, the output module 515 may receive signals from other components of the device 505, such as the LLM service 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the LLM service 520 may include an LLM agent configuration component 525, a first message component 530, a control message component 535, a parameter weight application switching component 540, or any combination thereof. In some examples, the LLM service 520, or various components thereof, may be configured to perform various operations (e.g., receiving, monitoring, transmitting) using or otherwise in cooperation with the input module 510, the output module 515, or both. For example, the LLM service 520 may receive information from the input module 510, send information to the output module 515, or be integrated in combination with the input module 510, the output module 515, or both to receive information, transmit information, or perform various other operations as described herein.

The LLM service 520 may support large language model (LLM) prompt parameter weight control in accordance with examples as disclosed herein. The LLM agent configuration component 525 may be configured to support configuring a first LLM agent and a second LLM agent with a first set of parameters for a first LLM prompt and a second set of parameters for a second LLM prompt that are different for the first LLM agent and the second LLM agent. The LLM agent configuration component 525 may be configured to support configuring a third LLM agent with the first set of parameters for the first LLM prompt at the first LLM agent in response to configuration of the first LLM agent. The first message component 530 may be configured to support obtaining, from the first LLM agent, a first message including a first set of content that is generated based on the first set of parameters for the first LLM prompt at the first LLM agent and the second set of parameters for the second LLM prompt at the first LLM agent. The control message component 535 may be configured to support obtaining, from the third LLM agent, a control message from the third LLM agent including an indication that is based on the first set of content of the first message. The parameter weight application switching component 540 may be configured to support switching, in response to obtaining the control message from the third LLM agent and based on the indication of the control message, from applying a first set of parameter weights to an LLM associated the first LLM agent to applying a second set of parameter weights to the LLM, the first set of parameter weights being different from the second set of parameter weights. The first message component 530 may be configured to support outputting, to the second LLM agent, the first message obtained from the first LLM agent based on the indication of the control message and switching to applying the second set of parameter weights to the LLM. The parameter weight application switching component 540 may be configured to support switching, in response to outputting the first message, from applying the second set of parameter weights to the LLM associated with the first LLM agent to applying the first set of parameter weights to the LLM.

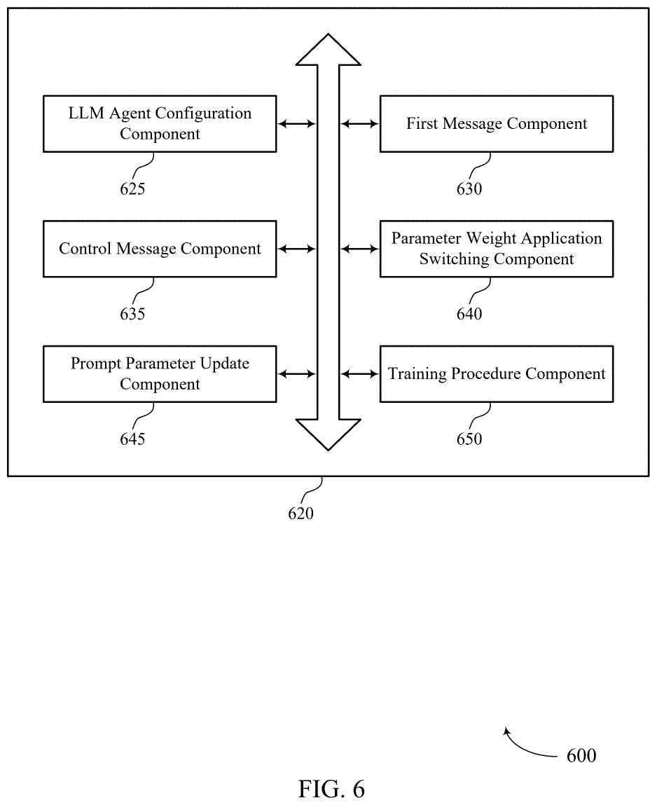

FIG. 6 shows a block diagram 600 of an LLM service 620 that supports content-based model weight adjustment in accordance with aspects of the present disclosure. The LLM service 620 may be an example of aspects of an LLM service or an LLM service 520, or both, as described herein. The LLM service 620, or various components thereof, may be an example of means for performing various aspects of content-based model weight adjustment as described herein. For example, the LLM service 620 may include an LLM agent configuration component 625, a first message component 630, a control message component 635, a parameter weight application switching component 640, a prompt parameter update component 645, a training procedure component 650, or any combination thereof. Each of these components, or components of subcomponents thereof (e.g., one or more processors, one or more memories), may communicate, directly or indirectly, with one another (e.g., via one or more buses).

The LLM service 620 may support large language model (LLM) prompt parameter weight control in accordance with examples as disclosed herein. The LLM agent configuration component 625 may be configured to support configuring a first LLM agent and a second LLM agent with a first set of parameters for a first LLM prompt and a second set of parameters for a second LLM prompt that are different for the first LLM agent and the second LLM agent. In some examples, the LLM agent configuration component 625 may be configured to support configuring a third LLM agent with the first set of parameters for the first LLM prompt at the first LLM agent in response to configuration of the first LLM agent. The first message component 630 may be configured to support obtaining, from the first LLM agent, a first message including a first set of content that is generated based on the first set of parameters for the first LLM prompt at the first LLM agent and the second set of parameters for the second LLM prompt at the first LLM agent. The control message component 635 may be configured to support obtaining, from the third LLM agent, a control message from the third LLM agent including an indication that is based on the first set of content of the first message. The parameter weight application switching component 640 may be configured to support switching, in response to obtaining the control message from the third LLM agent and based on the indication of the control message, from applying a first set of parameter weights to an LLM associated the first LLM agent to applying a second set of parameter weights to the LLM, the first set of parameter weights being different from the second set of parameter weights. In some examples, the first message component 630 may be configured to support outputting, to the second LLM agent, the first message obtained from the first LLM agent based on the indication of the control message and switching to applying the second set of parameter weights to the LLM. In some examples, the parameter weight application switching component 640 may be configured to support switching, in response to outputting the first message, from applying the second set of parameter weights to the LLM associated with the first LLM agent to applying the first set of parameter weights to the LLM.

In some examples, the prompt parameter update component 645 may be configured to support updating, in response to outputting the first message, the second set of parameters for the second LLM prompt at both the first LLM agent and the second LLM agent, where updating the second set of parameters for the second LLM prompt at the second LLM agent includes providing the first message as an input to the second LLM agent.

In some examples, the first set of parameters for the first LLM prompt includes a scenario parameter, a role parameter, a goal parameter, and an instructions parameter, or any combination thereof.

In some examples, the second set of parameters for the second LLM prompt includes a session position indicator parameter, a messages parameter indicating one or messages from the first LLM agent and the second LLM agent, a cue for next message parameter, or any combination thereof.

In some examples, to support obtaining the control message, the control message component 635 may be configured to support obtaining, via the indication of the control message, a positive indication, a negative indication, or a termination indication based on the first set of content of the first message.

In some examples, the indication of the control message includes the positive indication based on the first set of content of the first message being in accordance with the first LLM prompt and the indication of the control message includes the negative indication based on the first set of content of the first message violating a configuration indicated by the first LLM prompt.

In some examples, the training procedure component 650 may be configured to support performing, prior to configuring the first LLM agent, the second LLM agent, and the third LLM agent, a training procedure to obtain the first set of parameter weights and the second set of parameter weights to apply to the LLM associated with the first LLM agent.

In some examples, to support performing the training procedure, the training procedure component 650 may be configured to support adjusting a first weight of at least one parameter weight of the second set of parameter weights of the LLM to be associated with the control message and a second weight of the at least one parameter weight of the second set of parameter weights of the LLM to be associated with a difference between a base set of parameters and a finetuned set of parameters associated with the first set of parameters of the first LLM prompt, where obtaining the second set of parameter weights is based on adjusting the first weight and the second weight.

In some examples, to support performing the training procedure, the training procedure component 650 may be configured to support training the first LLM agent, the second LLM agent, and the third LLM agent using a set of training data including one or more system messages, a session position indicator, one or messages from the first LLM agent, the second LLM agent, the third LLM agent, or any combination thereof, a cue for next message indication, a termination message from the third LLM agent, or any combination thereof, where obtaining the second set of parameter weights is based on training the first LLM agent, the second LLM agent, and the third LLM agent using the set of training data.

In some examples, the first message component 630 may be configured to support refraining from outputting the first message to the second LLM agent in response to the control message from the third LLM agent based on the indication of the control message. In some examples, the control message component 635 may be configured to support outputting, to the first LLM agent, the control message, where switching from applying the first set of parameter weights to the LLM to applying the second set of parameter weights to the LLM is based on outputting the control message. In some examples, the first message component 630 may be configured to support obtaining, from the first LLM agent, the first message including a second set of content that is generated based on the first set of parameters for the first LLM prompt at the first LLM agent and the second set of parameters for the second LLM prompt at the first LLM agent, the second set of content of the first message being based on the first set of content, where the second set of content is generated in accordance with the second set of parameter weights being applied to the LLM. In some examples, the control message component 635 may be configured to support obtaining, from the third LLM agent, a second control message a second indication that is based on the second set of content of the first message. In some examples, the first message component 630 may be configured to support outputting, to the second LLM agent, the first message obtained from the first LLM agent based on the second indication of the second control message and the second set of parameter weights being applied to the LLM, where switching from applying the second set of parameter weights to the LLM to applying the first set of parameter weights to the LLM is based on outputting the first message and obtaining the second control message.

FIG. 7 shows a diagram of a system 700 including a device 705 that supports content-based model weight adjustment in accordance with aspects of the present disclosure. The device 705 may be an example of or include components of a device 505 as described herein. The device 705 may include components for bi-directional data communications including components for transmitting and receiving communications, such as an LLM service 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting content-based model weight adjustment). The processor 730 may be an example of a single processor or multiple processors. For example, the device 705 may include one or more processors 730.

The LLM service 720 may support large language model (LLM) prompt parameter weight control in accordance with examples as disclosed herein. For example, the LLM service 720 may be configured to support configuring a first LLM agent and a second LLM agent with a first set of parameters for a first LLM prompt and a second set of parameters for a second LLM prompt that are different for the first LLM agent and the second LLM agent. The LLM service 720 may be configured to support configuring a third LLM agent with the first set of parameters for the first LLM prompt at the first LLM agent in response to configuration of the first LLM agent. The LLM service 720 may be configured to support obtaining, from the first LLM agent, a first message including a first set of content that is generated based on the first set of parameters for the first LLM prompt at the first LLM agent and the second set of parameters for the second LLM prompt at the first LLM agent. The LLM service 720 may be configured to support obtaining, from the third LLM agent, a control message from the third LLM agent including an indication that is based on the first set of content of the first message. The LLM service 720 may be configured to support switching, in response to obtaining the control message from the third LLM agent and based on the indication of the control message, from applying a first set of parameter weights to an LLM associated the first LLM agent to applying a second set of parameter weights to the LLM, the first set of parameter weights being different from the second set of parameter weights. The LLM service 720 may be configured to support outputting, to the second LLM agent, the first message obtained from the first LLM agent based on the indication of the control message and switching to applying the second set of parameter weights to the LLM. The LLM service 720 may be configured to support switching, in response to outputting the first message, from applying the second set of parameter weights to the LLM associated with the first LLM agent to applying the first set of parameter weights to the LLM.

By including or configuring the LLM service 720 in accordance with examples as described herein, the device 705 may support techniques for switching which parameter weights are applied to an LLM based on whether content generated by an LLM agent violates a configuration to support improved communication reliability, more accurate text generation via LLMs, improved coordination between LLM agents, improved reliability of LLM agents, and improved consistency of LLM agent actions.

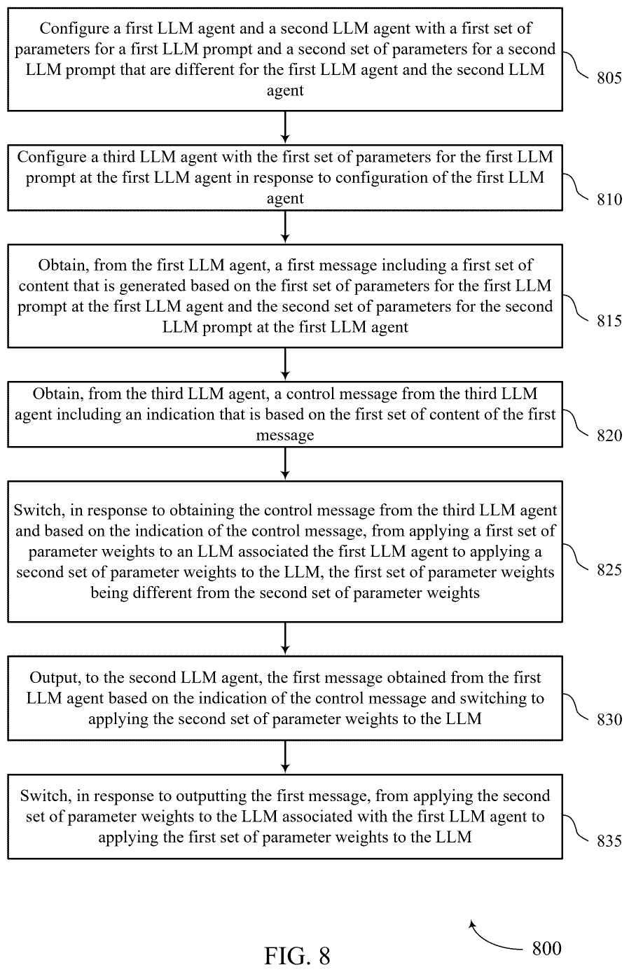

FIG. 8 shows a flowchart illustrating a method 800 that supports content-based model weight adjustment in accordance with aspects of the present disclosure. The operations of the method 800 may be implemented by a computing device or its components as described herein. For example, the operations of the method 800 may be performed by a computing device as described with reference to FIGS. 1 through 7. In some examples, a computing device may execute a set of instructions to control the functional elements of the computing device to perform the described functions. Additionally, or alternatively, the computing device may perform aspects of the described functions using special-purpose hardware.

At 805, the method may include configuring a first LLM agent and a second LLM agent with a first set of parameters for a first LLM prompt and a second set of parameters for a second LLM prompt that are different for the first LLM agent and the second LLM agent. The operations of 805 may be performed in accordance with examples as disclosed herein. In some examples, aspects of the operations of 805 may be performed by an LLM agent configuration component 625 as described with reference to FIG. 6.

At 810, the method may include configuring a third LLM agent with the first set of parameters for the first LLM prompt at the first LLM agent in response to configuration of the first LLM agent. The operations of 810 may be performed in accordance with examples as disclosed herein. In some examples, aspects of the operations of 810 may be performed by an LLM agent configuration component 625 as described with reference to FIG. 6.

At 815, the method may include obtaining, from the first LLM agent, a first message including a first set of content that is generated based on the first set of parameters for the first LLM prompt at the first LLM agent and the second set of parameters for the second LLM prompt at the first LLM agent. The operations of 815 may be performed in accordance with examples as disclosed herein. In some examples, aspects of the operations of 815 may be performed by a first message component 630 as described with reference to FIG. 6.

At 820, the method may include obtaining, from the third LLM agent, a control message from the third LLM agent including an indication that is based on the first set of content of the first message. The operations of 820 may be performed in accordance with examples as disclosed herein. In some examples, aspects of the operations of 820 may be performed by a control message component 635 as described with reference to FIG. 6.

At 825, the method may include switching, in response to obtaining the control message from the third LLM agent and based on the indication of the control message, from applying a first set of parameter weights to an LLM associated the first LLM agent to applying a second set of parameter weights to the LLM, the first set of parameter weights being different from the second set of parameter weights. The operations of 825 may be performed in accordance with examples as disclosed herein. In some examples, aspects of the operations of 825 may be performed by a parameter weight application switching component 640 as described with reference to FIG. 6.

At 830, the method may include outputting, to the second LLM agent, the first message obtained from the first LLM agent based on the indication of the control message and switching to applying the second set of parameter weights to the LLM. The operations of 830 may be performed in accordance with examples as disclosed herein. In some examples, aspects of the operations of 830 may be performed by a first message component 630 as described with reference to FIG. 6.

At 835, the method may include switching, in response to outputting the first message, from applying the second set of parameter weights to the LLM associated with the first LLM agent to applying the first set of parameter weights to the LLM. The operations of 835 may be performed in accordance with examples as disclosed herein. In some examples, aspects of the operations of 835 may be performed by a parameter weight application switching component 640 as described with reference to FIG. 6.

A method for large language model (LLM) prompt parameter weight control by an apparatus is described. The method may include configuring a first LLM agent and a second LLM agent with a first set of parameters for a first LLM prompt and a second set of parameters for a second LLM prompt that are different for the first LLM agent and the second LLM agent, configuring a third LLM agent with the first set of parameters for the first LLM prompt at the first LLM agent in response to configuration of the first LLM agent, obtaining, from the first LLM agent, a first message including a first set of content that is generated based on the first set of parameters for the first LLM prompt at the first LLM agent and the second set of parameters for the second LLM prompt at the first LLM agent, obtaining, from the third LLM agent, a control message from the third LLM agent including an indication that is based on the first set of content of the first message, switching, in response to obtaining the control message from the third LLM agent and based on the indication of the control message, from applying a first set of parameter weights to an LLM associated the first LLM agent to applying a second set of parameter weights to the LLM, the first set of parameter weights being different from the second set of parameter weights, outputting, to the second LLM agent, the first message obtained from the first LLM agent based on the indication of the control message and switching to applying the second set of parameter weights to the LLM, and switching, in response to outputting the first message, from applying the second set of parameter weights to the LLM associated with the first LLM agent to applying the first set of parameter weights to the LLM.

An apparatus for large language model (LLM) prompt parameter weight control is described. The apparatus may include one or more memories storing processor executable code, and one or more processors coupled with the one or more memories. The one or more processors may individually or collectively be operable to execute the code to cause the apparatus to configure a first LLM agent and a second LLM agent with a first set of parameters for a first LLM prompt and a second set of parameters for a second LLM prompt that are different for the first LLM agent and the second LLM agent, configure a third LLM agent with the first set of parameters for the first LLM prompt at the first LLM agent in response to configuration of the first LLM agent, obtain, from the first LLM agent, a first message including a first set of content that is generated based on the first set of parameters for the first LLM prompt at the first LLM agent and the second set of parameters for the second LLM prompt at the first LLM agent, obtain, from the third LLM agent, a control message from the third LLM agent including an indication that is based on the first set of content of the first message, switching, in response to obtain the control message from the third LLM agent and based on the indication of the control message, from applying a first set of parameter weights to an LLM associated the first LLM agent to applying a second set of parameter weights to the LLM, the first set of parameter weights being different from the second set of parameter weights, output, to the second LLM agent, the first message obtained from the first LLM agent based on the indication of the control message and switching to applying the second set of parameter weights to the LLM, and switching, in response to output the first message, from applying the second set of parameter weights to the LLM associated with the first LLM agent to applying the first set of parameter weights to the LLM.

Another apparatus for large language model (LLM) prompt parameter weight control is described. The apparatus may include means for configuring a first LLM agent and a second LLM agent with a first set of parameters for a first LLM prompt and a second set of parameters for a second LLM prompt that are different for the first LLM agent and the second LLM agent, means for configuring a third LLM agent with the first set of parameters for the first LLM prompt at the first LLM agent in response to configuration of the first LLM agent, means for obtaining, from the first LLM agent, a first message including a first set of content that is generated based on the first set of parameters for the first LLM prompt at the first LLM agent and the second set of parameters for the second LLM prompt at the first LLM agent, means for obtaining, from the third LLM agent, a control message from the third LLM agent including an indication that is based on the first set of content of the first message, means for switching, in response to obtaining the control message from the third LLM agent and based on the indication of the control message, from applying a first set of parameter weights to an LLM associated the first LLM agent to applying a second set of parameter weights to the LLM, the first set of parameter weights being different from the second set of parameter weights, means for outputting, to the second LLM agent, the first message obtained from the first LLM agent based on the indication of the control message and switching to applying the second set of parameter weights to the LLM, and means for switching, in response to outputting the first message, from applying the second set of parameter weights to the LLM associated with the first LLM agent to applying the first set of parameter weights to the LLM.

A non-transitory computer-readable medium storing code for large language model (LLM) prompt parameter weight control is described. The code may include instructions executable by one or more processors to configure a first LLM agent and a second LLM agent with a first set of parameters for a first LLM prompt and a second set of parameters for a second LLM prompt that are different for the first LLM agent and the second LLM agent, configure a third LLM agent with the first set of parameters for the first LLM prompt at the first LLM agent in response to configuration of the first LLM agent, obtain, from the first LLM agent, a first message including a first set of content that is generated based on the first set of parameters for the first LLM prompt at the first LLM agent and the second set of parameters for the second LLM prompt at the first LLM agent, obtain, from the third LLM agent, a control message from the third LLM agent including an indication that is based on the first set of content of the first message, switching, in response to obtain the control message from the third LLM agent and based on the indication of the control message, from applying a first set of parameter weights to an LLM associated the first LLM agent to applying a second set of parameter weights to the LLM, the first set of parameter weights being different from the second set of parameter weights, output, to the second LLM agent, the first message obtained from the first LLM agent based on the indication of the control message and switching to applying the second set of parameter weights to the LLM, and switching, in response to output the first message, from applying the second set of parameter weights to the LLM associated with the first LLM agent to applying the first set of parameter weights to the LLM.

Some examples of the method, apparatus, and non-transitory computer-readable medium described herein may further include operations, features, means, or instructions for updating, in response to outputting the first message, the second set of parameters for the second LLM prompt at both the first LLM agent and the second LLM agent, where updating the second set of parameters for the second LLM prompt at the second LLM agent includes providing the first message as an input to the second LLM agent.

In some examples of the method, apparatus, and non-transitory computer-readable medium described herein, the first set of parameters for the first LLM prompt includes a scenario parameter, a role parameter, a goal parameter, and an instructions parameter, or any combination thereof.

In some examples of the method, apparatus, and non-transitory computer-readable medium described herein, the second set of parameters for the second LLM prompt includes a session position indicator parameter, a messages parameter indicating one or messages from the first LLM agent and the second LLM agent, a cue for next message parameter, or any combination thereof.

In some examples of the method, apparatus, and non-transitory computer-readable medium described herein, obtaining the control message may include operations, features, means, or instructions for obtaining, via the indication of the control message, a positive indication, a negative indication, or a termination indication based on the first set of content of the first message.

In some examples of the method, apparatus, and non-transitory computer-readable medium described herein, the indication of the control message includes the positive indication based on the first set of content of the first message being in accordance with the first LLM prompt and the indication of the control message includes the negative indication based on the first set of content of the first message violating a configuration indicated by the first LLM prompt.

Some examples of the method, apparatus, and non-transitory computer-readable medium described herein may further include operations, features, means, or instructions for performing, prior to configuring the first LLM agent, the second LLM agent, and the third LLM agent, a training procedure to obtain the first set of parameter weights and the second set of parameter weights to apply to the LLM associated with the first LLM agent.

In some examples of the method, apparatus, and non-transitory computer-readable medium described herein, performing the training procedure may include operations, features, means, or instructions for adjusting a first parameter weight of the second set of parameter weights of the LLM to be associated with the control message including a negative indication and a second parameter weight of the second set of parameter weights of the LLM to be associated with a finetuned set of parameters for the LLM associated the first LLM agent diverging from a base set of parameters for the LLM, where obtaining the second set of parameter weights is based on adjusting the first parameter weight and the second parameter weight, and where the first parameter weight and the second parameter weight are associated with a loss parameter applied to the LLM associated with the first LLM agent.

In some examples of the method, apparatus, and non-transitory computer-readable medium described herein, performing the training procedure may include operations, features, means, or instructions for training the first LLM agent, the second LLM agent, and the third LLM agent using a set of training data including one or more system messages, a session position indicator, one or messages from the first LLM agent, the second LLM agent, the third LLM agent, or any combination thereof, a cue for next message indication, a termination message from the third LLM agent, or any combination thereof, where obtaining the second set of parameter weights may be based on training the first LLM agent, the second LLM agent, and the third LLM agent using the set of training data.

Some examples of the method, apparatus, and non-transitory computer-readable medium described herein may further include operations, features, means, or instructions for refraining from outputting the first message to the second LLM agent in response to the control message from the third LLM agent based on the indication of the control message, outputting, to the first LLM agent, the control message, where switching from applying the first set of parameter weights to the LLM to applying the second set of parameter weights to the LLM may be based on outputting the control message, obtaining, from the first LLM agent, the first message including a second set of content that may be generated based on the first set of parameters for the first LLM prompt at the first LLM agent and the second set of parameters for the second LLM prompt at the first LLM agent, the second set of content of the first message being based on the first set of content, where the second set of content may be generated in accordance with the second set of parameter weights being applied to the LLM, obtaining, from the third LLM agent, a second control message a second indication that may be based on the second set of content of the first message, and outputting, to the second LLM agent, the first message obtained from the first LLM agent based on the second indication of the second control message and the second set of parameter weights being applied to the LLM, where switching from applying the second set of parameter weights to the LLM to applying the first set of parameter weights to the LLM may be based on outputting the first message and obtaining the second control message.

The following provides an overview of aspects of the present disclosure:

Aspect 1: A method for large language model (LLM) prompt parameter weight control, comprising: configuring a first LLM agent and a second LLM agent with a first set of parameters for a first LLM prompt and a second set of parameters for a second LLM prompt that are different for the first LLM agent and the second LLM agent; configuring a third LLM agent with the first set of parameters for the first LLM prompt at the first LLM agent in response to configuration of the first LLM agent; obtaining, from the first LLM agent, a first message comprising a first set of content that is generated based at least in part on the first set of parameters for the first LLM prompt at the first LLM agent and the second set of parameters for the second LLM prompt at the first LLM agent; obtaining, from the third LLM agent, a control message from the third LLM agent comprising an indication that is based at least in part on the first set of content of the first message; switching, in response to obtaining the control message from the third LLM agent and based at least in part on the indication of the control message, from applying a first set of parameter weights to an LLM associated the first LLM agent to applying a second set of parameter weights to the LLM, the first set of parameter weights being different from the second set of parameter weights; outputting, to the second LLM agent, the first message obtained from the first LLM agent based at least in part on the indication of the control message and switching to applying the second set of parameter weights to the LLM; and switching, in response to outputting the first message, from applying the second set of parameter weights to the LLM associated with the first LLM agent to applying the first set of parameter weights to the LLM.

Aspect 2: The method of aspect 1, further comprising: updating, in response to outputting the first message, the second set of parameters for the second LLM prompt at both the first LLM agent and the second LLM agent, where updating the second set of parameters for the second LLM prompt at the second LLM agent includes providing the first message as an input to the second LLM agent.

Aspect 3: The method of any of aspects 1 through 2, wherein the first set of parameters for the first LLM prompt comprises a scenario parameter, a role parameter, a goal parameter, and an instructions parameter, or any combination thereof.

Aspect 4: The method of any of aspects 1 through 3, wherein the second set of parameters for the second LLM prompt comprises a session position indicator parameter, a messages parameter indicating one or messages from the first LLM agent and the second LLM agent, a cue for next message parameter, or any combination thereof.

Aspect 5: The method of any of aspects 1 through 4, wherein obtaining the control message comprises: obtaining, via the indication of the control message, a positive indication, a negative indication, or a termination indication based at least in part on the first set of content of the first message.

Aspect 6: The method of aspect 5, wherein the indication of the control message comprises the positive indication based at least in part on the first set of content of the first message being in accordance with the first LLM prompt and the indication of the control message comprises the negative indication based at least in part on the first set of content of the first message violating a configuration indicated by the first LLM prompt.

Aspect 7: The method of any of aspects 1 through 6, further comprising: performing, prior to configuring the first LLM agent, the second LLM agent, and the third LLM agent, a training procedure to obtain the first set of parameter weights and the second set of parameter weights to apply to the LLM associated with the first LLM agent.

Aspect 8: The method of aspect 7, wherein performing the training procedure comprises: adjusting a first parameter weight of the second set of parameter weights of the LLM to be associated with the control message comprising a negative indication and a second parameter weight of the second set of parameter weights of the LLM to be associated with a finetuned set of parameters for the LLM associated the first LLM agent diverging from a base set of parameters for the LLM, wherein obtaining the second set of parameter weights is based at least in part on adjusting the first parameter weight and the second parameter weight, and wherein the first parameter weight and the second parameter weight are associated with a loss parameter applied to the LLM associated with the first LLM agent.

Aspect 9: The method of any of aspects 7 through 8, wherein performing the training procedure comprises: training the first LLM agent, the second LLM agent, and the third LLM agent using a set of training data comprising one or more system messages, a session position indicator, one or messages from the first LLM agent, the second LLM agent, the third LLM agent, or any combination thereof, a cue for next message indication, a termination message from the third LLM agent, or any combination thereof, wherein obtaining the second set of parameter weights is based at least in part on training the first LLM agent, the second LLM agent, and the third LLM agent using the set of training data.

Aspect 10: The method of any of aspects 1 through 9, further comprising: refraining from outputting the first message to the second LLM agent in response to the control message from the third LLM agent based at least in part on the indication of the control message; outputting, to the first LLM agent, the control message, wherein switching from applying the first set of parameter weights to the LLM to applying the second set of parameter weights to the LLM is based at least in part on outputting the control message; obtaining, from the first LLM agent, the first message comprising a second set of content that is generated based at least in part on the first set of parameters for the first LLM prompt at the first LLM agent and the second set of parameters for the second LLM prompt at the first LLM agent, the second set of content of the first message being based at least in part on the first set of content, wherein the second set of content is generated in accordance with the second set of parameter weights being applied to the LLM; obtaining, from the third LLM agent, a second control message a second indication that is based at least in part on the second set of content of the first message; and outputting, to the second LLM agent, the first message obtained from the first LLM agent based at least in part on the second indication of the second control message and the second set of parameter weights being applied to the LLM, wherein switching from applying the second set of parameter weights to the LLM to applying the first set of parameter weights to the LLM is based at least in part on outputting the first message and obtaining the second control message.

Aspect 11: An apparatus for large language model (LLM) prompt parameter weight control, comprising one or more memories storing processor-executable code, and one or more processors coupled with the one or more memories and individually or collectively operable to execute the code to cause the apparatus to perform a method of any of aspects 1 through 10.

Aspect 12: An apparatus for large language model (LLM) prompt parameter weight control, comprising at least one means for performing a method of any of aspects 1 through 10.

Aspect 13: A non-transitory computer-readable medium storing code for large language model (LLM) prompt parameter weight control, the code comprising instructions executable by one or more processors to perform a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for large language model (LLM) prompt parameter weight control, comprising:
configuring a first LLM agent and a second LLM agent with a first set of parameters for a first LLM prompt and a second set of parameters for a second LLM prompt that are different for the first LLM agent and the second LLM agent;
configuring a third LLM agent with the first set of parameters for the first LLM prompt at the first LLM agent in response to configuration of the first LLM agent;
obtaining, from the first LLM agent, a first message comprising a first set of content that is generated based at least in part on the first set of parameters for the first LLM prompt at the first LLM agent and the second set of parameters for the second LLM prompt at the first LLM agent;
obtaining, from the third LLM agent, a control message from the third LLM agent comprising an indication that is based at least in part on the first set of content of the first message;
switching, in response to obtaining the control message from the third LLM agent and based at least in part on the indication of the control message, from applying a first set of parameter weights to an LLM associated the first LLM agent to applying a second set of parameter weights to the LLM, the first set of parameter weights being different from the second set of parameter weights;
outputting, to the second LLM agent, the first message obtained from the first LLM agent based at least in part on the indication of the control message and switching to applying the second set of parameter weights to the LLM; and
switching, in response to outputting the first message, from applying the second set of parameter weights to the LLM associated with the first LLM agent to applying the first set of parameter weights to the LLM.

2. The method of claim 1, further comprising:
updating, in response to outputting the first message, the second set of parameters for the second LLM prompt at both the first LLM agent and the second LLM agent, wherein updating the second set of parameters for the second LLM prompt at the second LLM agent comprises providing the first message as an input to the second LLM agent.

3. The method of claim 1, wherein the first set of parameters for the first LLM prompt comprises a scenario parameter, a role parameter, a goal parameter, and an instructions parameter, or any combination thereof.

4. The method of claim 1, wherein the second set of parameters for the second LLM prompt comprises a session position indicator parameter, a messages parameter indicating one or messages from the first LLM agent and the second LLM agent, a cue for next message parameter, or any combination thereof.

5. The method of claim 1, wherein obtaining the control message comprises:
obtaining, via the indication of the control message, a positive indication, a negative indication, or a termination indication based at least in part on the first set of content of the first message.

6. The method of claim 5, wherein the indication of the control message comprises the positive indication based at least in part on the first set of content of the first message being in accordance with the first LLM prompt and the indication of the control message comprises the negative indication based at least in part on the first set of content of the first message violating a configuration indicated by the first LLM prompt.

7. The method of claim 1, further comprising:
performing, prior to configuring the first LLM agent, the second LLM agent, and the third LLM agent, a training procedure to obtain the first set of parameter weights and the second set of parameter weights to apply to the LLM associated with the first LLM agent.

8. The method of claim 7, wherein performing the training procedure comprises:
adjusting a first parameter weight of the second set of parameter weights of the LLM to be associated with the control message comprising a negative indication and a second parameter weight of the second set of parameter weights of the LLM to be associated with a finetuned set of parameters for the LLM associated the first LLM agent diverging from a base set of parameters for the LLM, wherein obtaining the second set of parameter weights is based at least in part on adjusting the first parameter weight and the second parameter weight, and wherein the first parameter weight and the second parameter weight are associated with a loss parameter applied to the LLM associated with the first LLM agent.

9. The method of claim 7, wherein performing the training procedure comprises:
training the first LLM agent, the second LLM agent, and the third LLM agent using a set of training data comprising one or more system messages, a session position indicator, one or messages from the first LLM agent, the second LLM agent, the third LLM agent, or any combination thereof, a cue for next message indication, a termination message from the third LLM agent, or any combination thereof, wherein obtaining the second set of parameter weights is based at least in part on training the first LLM agent, the second LLM agent, and the third LLM agent using the set of training data.

10. The method of claim 1, further comprising:
refraining from outputting the first message to the second LLM agent in response to the control message from the third LLM agent based at least in part on the indication of the control message;
outputting, to the first LLM agent, the control message, wherein switching from applying the first set of parameter weights to the LLM to applying the second set of parameter weights to the LLM is based at least in part on outputting the control message;
obtaining, from the first LLM agent, the first message comprising a second set of content that is generated based at least in part on the first set of parameters for the first LLM prompt at the first LLM agent and the second set of parameters for the second LLM prompt at the first LLM agent, the second set of content of the first message being based at least in part on the first set of content, wherein the second set of content is generated in accordance with the second set of parameter weights being applied to the LLM;
obtaining, from the third LLM agent, a second control message a second indication that is based at least in part on the second set of content of the first message; and
outputting, to the second LLM agent, the first message obtained from the first LLM agent based at least in part on the second indication of the second control message and the second set of parameter weights being applied to the LLM, wherein switching from applying the second set of parameter weights to the LLM to applying the first set of parameter weights to the LLM is based at least in part on outputting the first message and obtaining the second control message.

11. An apparatus for large language model (LLM) prompt parameter weight control, comprising:
one or more memories storing processor-executable code; and
one or more processors coupled with the one or more memories and individually or collectively operable to execute the code to cause the apparatus to:
configure a first LLM agent and a second LLM agent with a first set of parameters for a first LLM prompt and a second set of parameters for a second LLM prompt that are different for the first LLM agent and the second LLM agent;
configure a third LLM agent with the first set of parameters for the first LLM prompt at the first LLM agent in response to configuration of the first LLM agent;
obtain, from the first LLM agent, a first message comprising a first set of content that is generated based at least in part on the first set of parameters for the first LLM prompt at the first LLM agent and the second set of parameters for the second LLM prompt at the first LLM agent;
obtain, from the third LLM agent, a control message from the third LLM agent comprising an indication that is based at least in part on the first set of content of the first message;
switch, in response to obtaining the control message from the third LLM agent and based at least in part on the indication of the control message, from applying a first set of parameter weights to an LLM associated the first LLM agent to applying a second set of parameter weights to the LLM, the first set of parameter weights being different from the second set of parameter weights;
output, to the second LLM agent, the first message obtained from the first LLM agent based at least in part on the indication of the control message and switching to applying the second set of parameter weights to the LLM; and
switch, in response to outputting the first message, from applying the second set of parameter weights to the LLM associated with the first LLM agent to applying the first set of parameter weights to the LLM.

12. The apparatus of claim 11, wherein the one or more processors are individually or collectively further operable to execute the code to cause the apparatus to:
update, in response to outputting the first message, the second set of parameters for the second LLM prompt at both the first LLM agent and the second LLM agent, wherein updating to the second set of parameters for the second LLM prompt at the second LLM agent comprises the first message being provided as an input to the second LLM agent.

13. The apparatus of claim 11, wherein, to obtain the control message, the one or more processors are individually or collectively operable to execute the code to cause the apparatus to:
obtain, via the indication of the control message, a positive indication, a negative indication, or a termination indication based at least in part on the first set of content of the first message.

14. The apparatus of claim 13, wherein the indication of the control message comprises the positive indication based at least in part on the first set of content of the first message being in accordance with the first LLM prompt and the indication of the control message comprises the negative indication based at least in part on the first set of content of the first message violating a configuration indicated by the first LLM prompt.

15. The apparatus of claim 11, wherein the one or more processors are individually or collectively further operable to execute the code to cause the apparatus to:
perform, prior to configuring the first LLM agent, the second LLM agent, and the third LLM agent, a training procedure to obtain the first set of parameter weights and the second set of parameter weights to apply to the LLM associated with the first LLM agent.

16. The apparatus of claim 11, wherein the one or more processors are individually or collectively further operable to execute the code to cause the apparatus to:
refrain from outputting the first message to the second LLM agent in response to the control message from the third LLM agent based at least in part on the indication of the control message;
output, to the first LLM agent, the control message, wherein switching from applying the first set of parameter weights to the LLM to applying the second set of parameter weights to the LLM is based at least in part on outputting the control message;
obtain, from the first LLM agent, the first message comprising a second set of content that is generated based at least in part on the first set of parameters for the first LLM prompt at the first LLM agent and the second set of parameters for the second LLM prompt at the first LLM agent, the second set of content of the first message being based at least in part on the first set of content, wherein the second set of content is generated in accordance with the second set of parameter weights being applied to the LLM;
obtain, from the third LLM agent, a second control message a second indication that is based at least in part on the second set of content of the first message; and
output, to the second LLM agent, the first message obtained from the first LLM agent based at least in part on the second indication of the second control message and the second set of parameter weights being applied to the LLM, wherein switching from applying the second set of parameter weights to the LLM to applying the first set of parameter weights to the LLM is based at least in part on outputting the first message and obtaining the second control message.

17. A non-transitory computer-readable medium storing code for large language model (LLM) prompt parameter weight control, the code comprising instructions executable by one or more processors to:
configure a first LLM agent and a second LLM agent with a first set of parameters for a first LLM prompt and a second set of parameters for a second LLM prompt that are different for the first LLM agent and the second LLM agent;
configure a third LLM agent with the first set of parameters for the first LLM prompt at the first LLM agent in response to configuration of the first LLM agent;
obtain, from the first LLM agent, a first message comprising a first set of content that is generated based at least in part on the first set of parameters for the first LLM prompt at the first LLM agent and the second set of parameters for the second LLM prompt at the first LLM agent;
obtain, from the third LLM agent, a control message from the third LLM agent comprising an indication that is based at least in part on the first set of content of the first message;
switch, in response to obtaining the control message from the third LLM agent and based at least in part on the indication of the control message, from applying a first set of parameter weights to an LLM associated the first LLM agent to applying a second set of parameter weights to the LLM, the first set of parameter weights being different from the second set of parameter weights;
output, to the second LLM agent, the first message obtained from the first LLM agent based at least in part on the indication of the control message and switching to applying the second set of parameter weights to the LLM; and
switch, in response to outputting the first message, from applying the second set of parameter weights to the LLM associated with the first LLM agent to applying the first set of parameter weights to the LLM.

18. The non-transitory computer-readable medium of claim 17, wherein the instructions are further executable by the one or more processors to:
update, in response to outputting the first message, the second set of parameters for the second LLM prompt at both the first LLM agent and the second LLM agent, wherein updating to the second set of parameters for the second LLM prompt at the second LLM agent comprises the first message being provided as an input to the second LLM agent.

19. The non-transitory computer-readable medium of claim 17, wherein the instructions are further executable by the one or more processors to:
perform, prior to configuring the first LLM agent, the second LLM agent, and the third LLM agent, a training procedure to obtain the first set of parameter weights and the second set of parameter weights to apply to the LLM associated with the first LLM agent.

20. The non-transitory computer-readable medium of claim 17, wherein the instructions are further executable by the one or more processors to:
refrain from outputting the first message to the second LLM agent in response to the control message from the third LLM agent based at least in part on the indication of the control message;
output, to the first LLM agent, the control message, wherein switching from applying the first set of parameter weights to the LLM to applying the second set of parameter weights to the LLM is based at least in part on outputting the control message;
obtain, from the first LLM agent, the first message comprising a second set of content that is generated based at least in part on the first set of parameters for the first LLM prompt at the first LLM agent and the second set of parameters for the second LLM prompt at the first LLM agent, the second set of content of the first message being based at least in part on the first set of content, wherein the second set of content is generated in accordance with the second set of parameter weights being applied to the LLM;
obtain, from the third LLM agent, a second control message a second indication that is based at least in part on the second set of content of the first message; and
output, to the second LLM agent, the first message obtained from the first LLM agent based at least in part on the second indication of the second control message and the second set of parameter weights being applied to the LLM, wherein switching from applying the second set of parameter weights to the LLM to applying the first set of parameter weights to the LLM is based at least in part on outputting the first message and obtaining the second control message.
